(19) United States
(12) Patent Application Publication
(10) Pub. No.: US 2022/0389984 A1
(43) Pub. Date: Dec. 8, 2022

(54) Ferro-Fluid Motion Damper with Visco-Restrictive Barrier

(71) Applicants: David J. Bolig, Martinez, CA (US); Martha Bolig, Martinez, CA (US)

(72) Inventors: David J. Bolig, Martinez, CA (US); Martha Bolig, Martinez, CA (US)

(21) Appl. No.: 17/887,381

(22) Filed: Aug. 12, 2022

Related U.S. Application Data
(63) Continuation-in-part of application No. 16/911,339, filed on Jun. 24, 2020.
Application No. 16/911,339 is a continuation-in-part of application No. 16/813,569, filed on Mar. 9, 2020, now abandoned.
(60) Provisional application No. 62/815,246, filed on Mar. 7, 2019.

(51) Int. Cl. F16F 9/53; F16F 9/32

(52) U.S. Cl. CPC F16F 9/535; F16F 9/3292; A42B 3/0473

(57) ABSTRACT

Described herein is motion damper comprising an elastically deformable sealed exterior housing, a perforated interior housing wholly contained within said exterior housing having at least one perforation, a visco-adaptive fluid contained with said exterior housing and

an activating system adapted to selectively modify the viscosity of said visco-adaptive fluid and thus modify the elastic properties of the motion damper.

### CROSS-REFERENCE TO RELATED APPLICATION(S)

### Claim of Priority

This application is a Continuation-In=Part of prior-filed and co-pending U.S. patent application Ser. No. 16/911,399, filed Jun. 24, 2020, which is a Continuation-in-Part of U.S. patent application Ser. No. 16/813,569, filed Mar. 9, 2020, which claims the benefit of priority of U.S. Provisional Application 62/815,246, filed Mar. 7, 2019, the complete contents of each of which are hereby incorporated herein by reference.

### BACKGROUND

### Technical Field

The present device pertains to the field of dampers and more specifically to the ferro-fluid motion dampers with visco-restrictive barriers.

### Background

Devices that can minimize impact or other effects of forces are used in a variety of applications, from personal protective equipment to earthquake structural support. These devices can mitigate force through shielding from an impact, absorbing impact, dissipating the force, transforming the kinetic energy of a force in to heat or another form of energy, for example.

Many activities, such as sports and transportation carry a risk of injury from the impact of a force. For example, football players wear specially designed helmets to protect players and minimize head and neck injuries. Motorcycle riders also wear helmets to protect the head and neck from unforeseen impacts.

Earthquakes can result in many casualties and billions of dollars in losses to property and business. Many large structures, such as skyscrapers, are built to withstand severe earthquakes through reinforcement mechanisms, but many also employ base isolators that allow a building to move with an earthquake to mitigate damage. However, many of these primarily rely on strictly mechanical means to resist a force in a passive manner.

What is needed is an impact reduction device that can be activated or deactivated in response to a force on a wide range of scales.

### BRIEF DESCRIPTION OF THE DRAWINGS

Further details of the present system are explained with the help of the attached drawings in which:

FIG. 1 is a cut-away perspective view of one embodiment of the present device

FIG. 2a is a perspective view of an embodiment of the present device incorporated into a helmet.

FIG. 2b is a side cross-sectional view of the embodiment in FIG. 2a.

FIG. 2c is a front cross-sectional view of the embodiment in FIG. 2a.

FIG. 2d is a perspective view of a front component of the embodiment in FIG. 2a.

FIG. 2e is a perspective view of a rear component of the embodiment in FIG. 2a.

FIG. 3 depicts a perspective expanded view of an embodiment of the present device.

FIG. 4 depicts a perspective expanded view of an embodiment of a visco-damping cartridge in the present device.

FIG. 5 depicts a perspective expanded view of an alternate embodiment of a cartridge in the present device.

FIG. 6 depicts a perspective expanded view of an alternate embodiment of a cartridge in the present device as a base isolator.

FIGS. 7a-7c depict embodiments of micro ferro-particles and their use within at least one device depicted and described herein.

FIG. 8a depicts a side view of another embodiment of a cartridge in the present device.

FIG. 8b depicts a side cutaway view of the embodiment shown in FIG. 8a.

FIG. 9a depicts a side view of another helmet embodiment of the present device.

FIG. 9b depicts a front view of the embodiment shown in FIG. 9a.

FIG. 9c depicts a rear view of the embodiment shown in FIG. 9a.

FIG. 9d depicts a top view of the embodiment shown in FIG. 9a.

FIG. 9e depicts a side cross-sectional view of the embodiment shown in FIG. 9a.

FIG. 9f depicts a rear cross-sectional view of the embodiment shown in FIG. 9a.

FIG. 9g depicts a front cross-sectional view of the embodiment shown in FIG. 9a.

FIG. 9h depicts a top cross-sectional view of the embodiment shown in FIG. 9a.

FIG. 10 depicts a side cross-sectional view of another embodiment of a cartridge in the present device.

FIG. 11a depicts a top cross-sectional view of another embodiment of a cartridge in the present device.

FIG. 11b depicts a side cross-sectional view of the embodiment shown in FIG. 11a.

FIG. 12a depicts a top cross-sectional view of the embodiment shown in FIGS. 11a-b in use in a base isolator.

FIG. 12b depicts a side cross-sectional view of the embodiment shown in FIG. 12a.

FIG. 13a depicts linear movement of the embodiment shown in FIGS. 12a-b in use.

FIG. 13b depicts relative motion of upper and lower plates of the embodiment shown in FIGS. 12a-b in use.

FIG. 13c depicts an identification scheme for the capsules in the embodiments shown in FIGS. 12a-b.

FIG. 13d depicts an example of an representing active and passive capsules in the embodiment shown in FIGS. 12a-b.

FIGS. 14a-d depict graphic representations of the motion of the embodiment shown in FIGS. 12a-b in use.

FIG. 15 depicts a flow diagram of a method of operation of an embodiment of the present device.

FIG. 16 depicts a flow diagram of a method of operation for another embodiment of the present device.

FIG. 17 depicts a computer system for implementing the methods described and depicted in FIGS. 16 and 17.

FIG. 18 depicts another embodiment of the present device having a switch-off device.

FIG. 19 depicts a flow diagram of operation of the embodiment shown in FIGS. 9a-h.

FIG. 20 depicts a schematic diagram of a base isolator system in use.

FIG. 21 depicts a flow diagram of the embodiment shown in FIGS. 10, 11a-b, 12a-b, 13a-d, 14a-d, and 15-17.

FIG. 22 depicts a perspective assembly view of another embodiment of a base isolator in use.

FIG. 23 depicts a perspective assembly view of another embodiment of the present device used in the embodiment shown in FIG. 22.

FIG. 24 depicts a perspective view of the embodiment shown in FIG. 22 in use.

FIG. 25a depicts a top view of the embodiment shown in FIG. 23 in use in a resting state.

FIG. 25b depicts a top view of the embodiment shown in FIG. 23 in use when a non-activating force is applied.

FIG. 25c depicts a top view of the embodiment shown in FIG. 23 in use when an activating force is applied.

### DETAILED DESCRIPTION

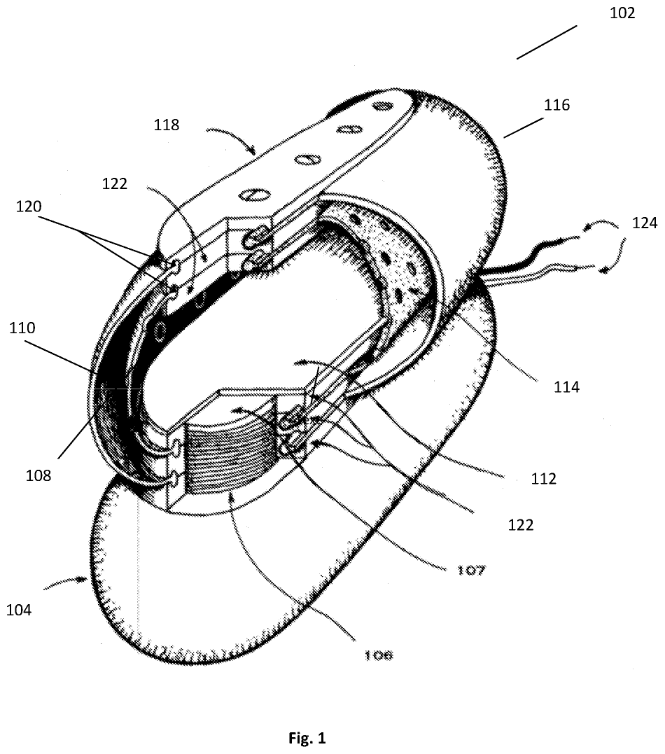

FIG. 1 depicts a perspective cutaway view of an embodiment of the present device. In some embodiments, a visco-restrictive damping cartridge 102 can have a rounded, elongated exterior geometry, but in other embodiments can have any other known and/or convenient geometry. A cartridge 102 can have an outermost first non-porous flexible membrane 104, which can be comprised of a polymer or any other known and/or convenient material.

An outermost membrane 104 can surround an inner capsule in which an electromagnet 106 can be placed between two substantially concentric magneto-rheologic fluid-containing capsules 108 110. A magneto-rheologic fluid can comprise powdered ferrous oxide, an oil carrier fluid, and a surfactant, or any other known and/or convenient substances. In some embodiments, an electromagnet 106 can have an elongated geometry, but in other embodiments can have any other known and/or convenient shape. As shown in FIG. 1, an electromagnet 106 can be topped by a metallic plate 112. In some embodiments, a metallic plate 112 can be comprised of steel or other ferro-magnetic material, but in other embodiments can be comprised of any other known and/or convenient material. In such embodiments, a metallic plate 112 can spread out a magnetic field emanating from an electromagnet 106 to enable more of a ferro-fluid to become thickened.

A flexible, perforated membrane 114 can separate the concentric ferro-fluid filled capsules encased by a second, nonporous membrane 116, which can be flexible or solid and form a housing. In some embodiments, a second, non-porous membrane 116 can be capable of elastic deformation. In some embodiments, a perforated membrane 114 can be formed from a woven fabric or perforated metallic sheet or any other known and/or convenient material. In some embodiments, in a first state, ferro-fluid can flow freely through a perforated membrane 114 between capsules, and in a second state be thickened and inert. However, in other embodiments ferrofluid can be thickened in a first state and free-flowing in a second state.

An upper mounting plate 118 and a lower mounting plate (not shown) can be positioned substantially opposite each other on the exterior of a membrane 116. Membranes 116 and 114 can have piped edges 120 that can be secured between a mounting plate 118 and elongated members 122, which can provide a seal sufficiently robust to contain the fluid under extreme pressure and prevent leaks. In some embodiments, mounting plates 118 and elongated members 122 can be comprised of high-density plastic, other polymer, metal, or any other known and/or convenient material.

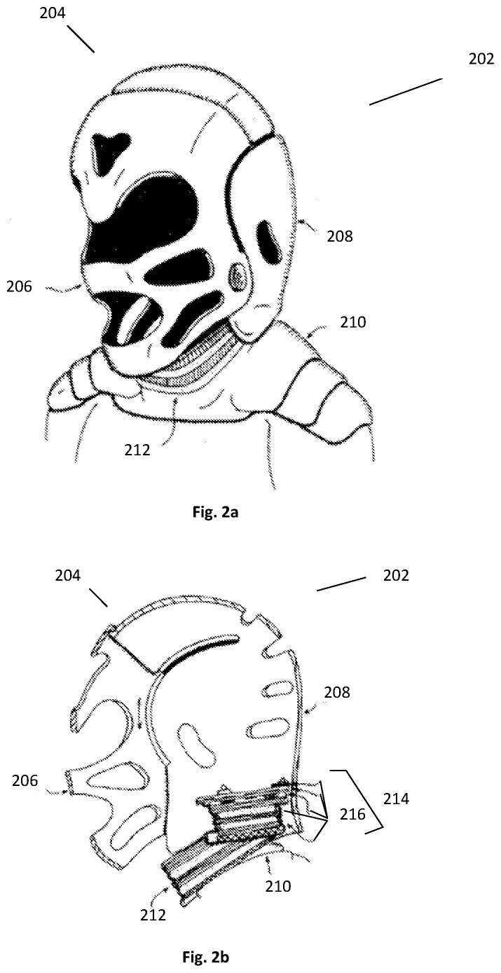

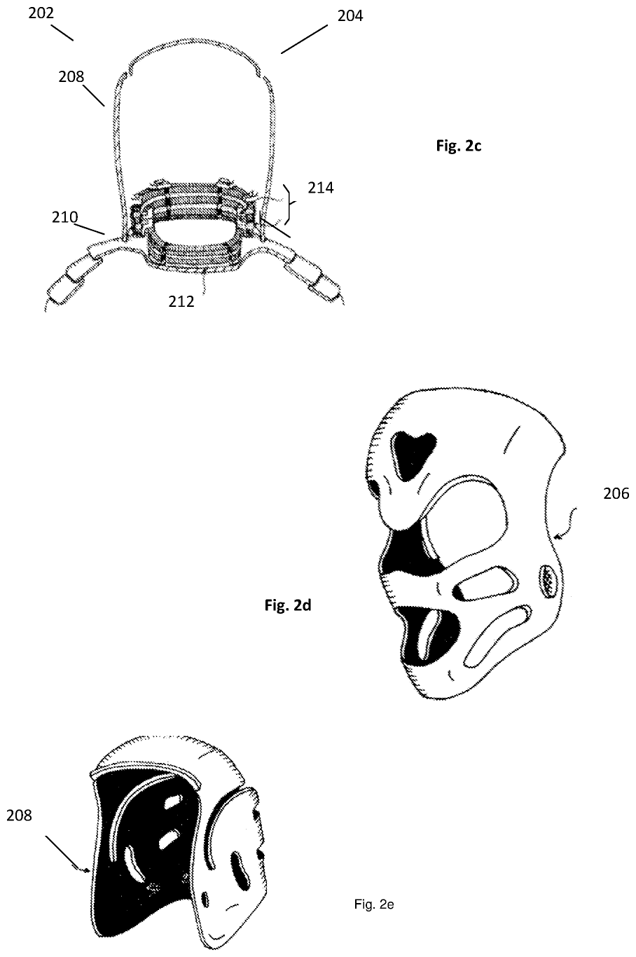

FIG. 2a depicts an exterior perspective view of an embodiment of the present device in use in a helmet system 202. A helmet 204 can be comprised of a face shield 206 and a rear helmet body component 208. A face shield 206 can slide up and over a helmet body 208. As shown in FIG. 2a, shoulder plates 210 can accompany a helmet 204. A collar connection unit 212 can connect a helmet body component 208 and shoulder plates 210. In some embodiments, a visco-restrictive cartridge can be housed in a collar connection unit 212. In some embodiments, components 206 208 210 212 can be comprised of a resin-infused fabric, polymer, metal, or any other known and/or convenient material. In some embodiments, minimizing the weight of the helmet 204 components can reduce inertial resistance and enhance accelerometer sensitivity to readily sense initial impact movement, which can allow faster activation of an electronic damping circuit to activate electromagnets 106.

FIG. 2b depicts a cross-sectional side view of the embodiment of a helmet system incorporating a visco-restrictive cartridge 102 shown in FIG. 2a, showing the interior view of a shock-absorbing assembly 214. In the embodiment shown, shock-absorbing assemblies can comprise a collar connection unit 212 and a helmet damper connection unit 216.

FIG. 2c depicts a cross-sectional front view of the helmet system embodiment shown in FIG. 2a.

FIG. 2d depicts a perspective view of a helmet face shield 206.

FIG. 2e depicts a perspective view of a helmet body component 208.

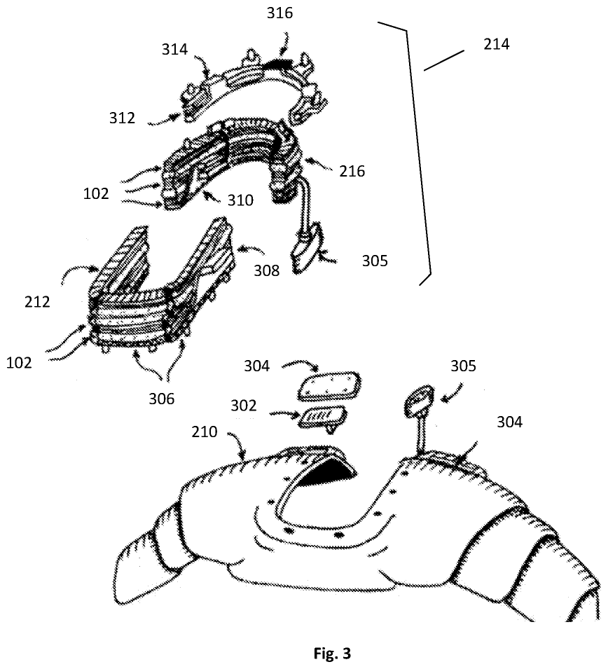

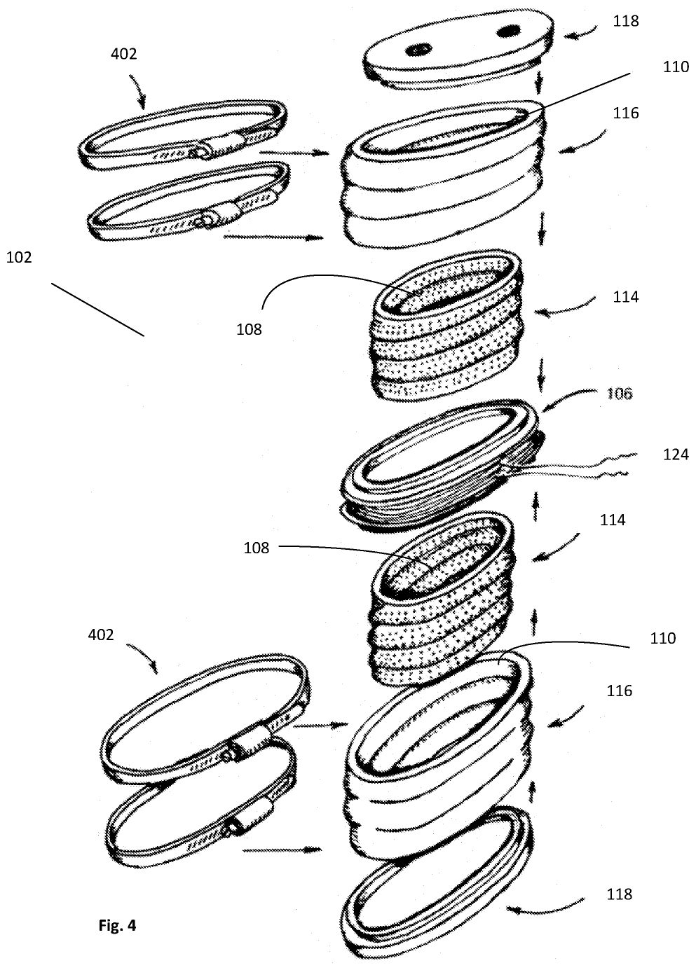

FIG. 3 depicts an exploded perspective view of one embodiment of the present device in a helmet system, In the embodiment shown, at least one power supply 302 can be housed in a holder 304 at the top of each side of shoulder plates 210, but in other embodiments can be placed in any other known and/or convenient location. A connector 305 can connect a power supply 302 to capacitors 306. A power supply 302 can supply electric current to capacitors 306, which can recharge between discharges.

As shown in FIG. 3, each damper connection unit 212 216 can comprise a plurality of ferro-fluid filled cartridges 102, each containing a double-sided electromagnet 106 and at least one capacitor 306. Interaction between slider elements 308 and 310 can permit the head to bow forward and down normally in a nodding motion. Affixed to a helmet body 204 can be a rotational track and 312 guide 314, which can permit a wearer's head to have normal rotational freedom to move left-to-right.

FIG. 4 depicts an exploded view of an alternate embodiment of a damping cartridge 102 depicted in FIG. 1. In some embodiments, a visco-restrictive damping cartridge 102 can have a rounded, elongated exterior geometry, but in other embodiments can have any other known and/or convenient geometry. A cartridge 102 can have an outermost second non-porous membrane 116, which, in some embodiments can be flexible. A non-porous membrane 106 can be comprised of a polymer, elastomer, or any other known and/or convenient material.

In the embodiment depicted in FIG. 4, a damping cartridge 102 can have upper and lower assemblies delineated by an electromagnet 106. Each assembly can comprise a perforated porous membrane 114 surrounded by a second non-porous membrane 116 and a mounting plates 118 on either end of the cartridge 102. In the embodiment depicted in FIG. 4, an electromagnet 106 can be coupled to each of the assemblies between and substantially aligned with mounting plates 118. In some embodiments, clamping mechanisms 402 can be employed to couple each of the assemblies with an electromagnet 106 and in some embodiments mounting plates 118 can be coupled with a second non-porous flexible membrane 116 via clamping mechanism 402. A clamping mechanism 402 can provide a seal sufficiently robust to contain the fluid under pressure and prevent leaks. In such embodiments, cartridges 102 can be arranged in a substantially colinear series. However, in alternate embodiments, any known convenient and/or desired sealant, mechanism and/or other known, convenient and/or desired attachment mechanism can be employed to couple the assemblies with mounting plates 118 and/or an electromagnet 106.

A damping cartridge 102 can be filled with a magneto-rheologic fluid and the magneto-rheologic fluid can comprise powdered ferrous oxide, an oil carrier fluid, and a surfactant, or any other known and/or convenient substance(s). In some embodiments, an electromagnet 106 can have an elliptical toroid geometry, but in other embodiments can have any other known, convenient and/or desired shape and/or geometry.

As depicted in FIG. 4, a flexible, perforated membrane 114 can be present within each of the assemblies. In some embodiments, a perforated membrane 114 can be formed from a woven fabric or perforated metallic sheet or any other known and/or convenient material. In a first state, which, in some embodiments can be a non-activated state, ferro-fluid can flow freely through a perforated membrane 114 between capsules. In such embodiments, a second state can be an activated state. In other embodiments, a first state can be an activated state and a second state a non-activated state.

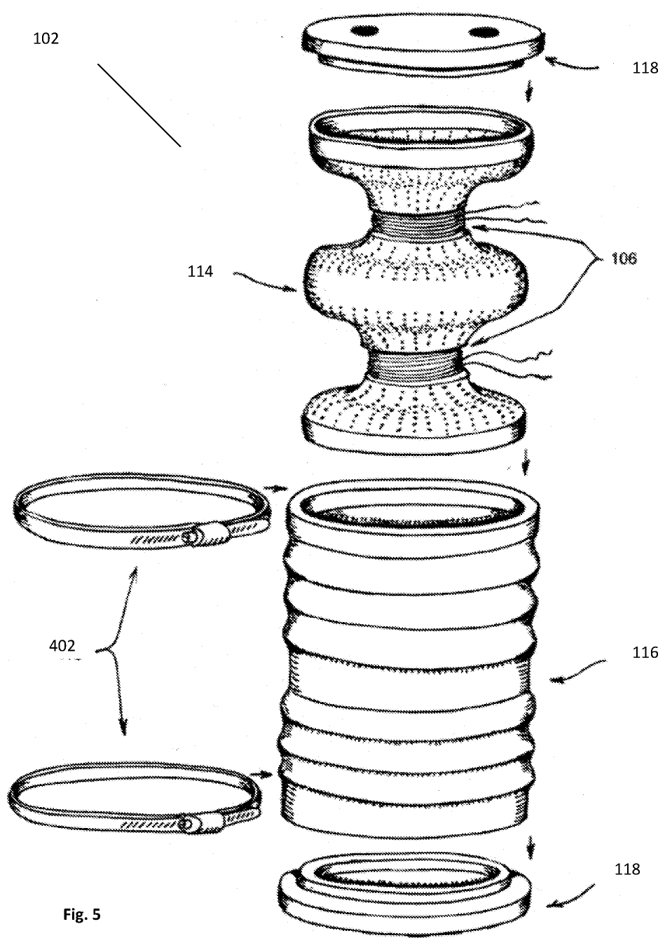

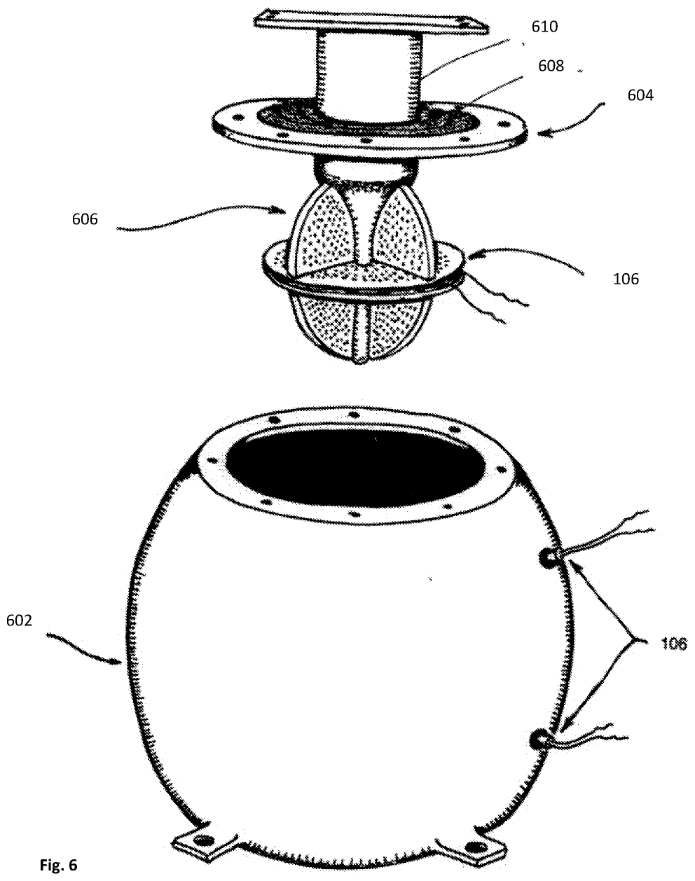

FIG. 5 depicts an exploded view of an alternate embodiment of a damping cartridge 102. As depicted in FIG. 5, a cartridge 102 can be comprised of an interior shaped perforated porous membrane 114 coupled with one or more electromagnets 106 surrounded by a substantially cylindrical non-porous membrane 116 which can have upper and lower mounting plates 118 which can be coupled with a non-porous membrane 116 via clamping mechanisms 402. In some embodiments in which a cartridge 102 comprises more than one electromagnet 106, each electromagnet 106 can be independently controlled to control the viscosity of the magneto-rheologic fluid contained within a cartridge 102. In the embodiment depicted in FIG. 5, a perforated porous membrane 114 can have the geometry of a cylinder having a diameter that varies along its length. Additionally, in some embodiments electromagnet(s) 106 can be located proximal to points of a minimum of the variable diameter cylinder. However, in alternate embodiments, various components can have any known convenient and/or desired shape, geometry, proportions and/or position relative to each other.

FIG. 6 depicts a disassembled view of an alternate embodiment of a damping cartridge 102. In the embodiment depicted in FIG. 6, a cartridge 102 can be comprised of a housing 602, a lid 604, a porous paddle 606, a flexible membrane 608, electromagnet(s) 106 and a connector element 610. In the embodiment depicted in FIG. 6, a porous paddle 606 can be directly coupled with connector element 610 which extends through a flexible membrane 608 and couples a connector element 610 and a porous paddle 606 with a lid 604 via a flexible membrane 608. A housing 602 can be filled with a magneto-rheologic fluid in which, when a lid 604 is attached to a housing 602, a porous paddle 606 can be at least partially submerged in the magneto-rheologic fluid. A lid 604 can then be coupled with a housing 602 such as to contain the magneto-rheologic fluid. A porous paddle 606, as depicted in FIG. 6 has a geometry of three, concentric, orthogonally joined circular plates. However, in alternate embodiments a porous paddle 606 can have any known, convenient and/or desired geometry, proportion(s) and/or configuration.

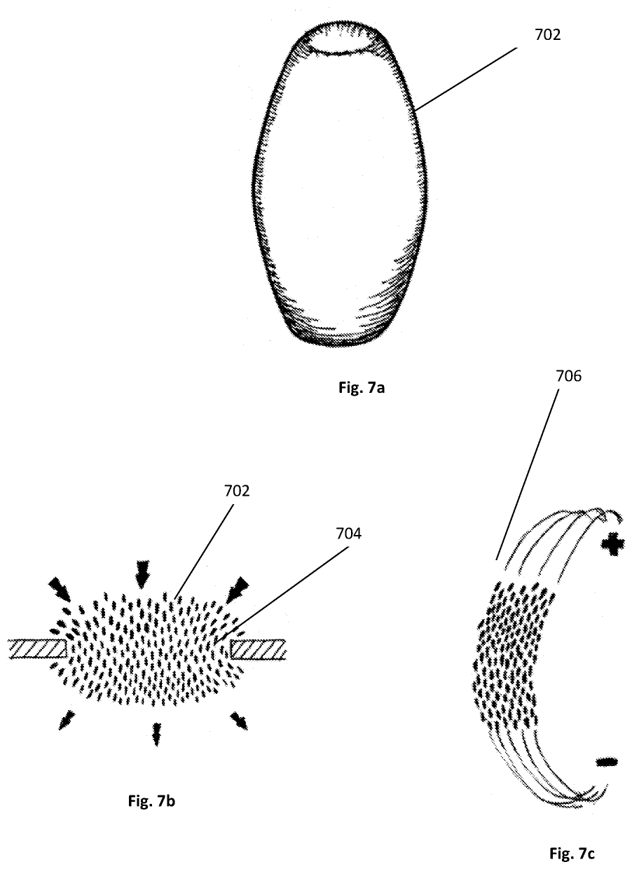

FIGS. 7a-7c depict embodiments of micro ferro-particles 702 and their use within at least one device depicted and described herein. FIG. 7a depicts an embodiment in which the ferro-particles 702 within the magneto-rheologic fluid have been shaped to have a substantially ellipsoid shape. Thus, as depicted in FIGS. 7b and 7c when ferro-particles 702 are aligned in the longitudinal direction relative to an opening 704, the ferro-particles 702 can more freely flow through an aperture and allow for a more compact and regular orientation of the ferro-particles 702 when subjected to a magnetic field 706. However, in other embodiments, ferro-particles can have any other known and/or convenient geometry.

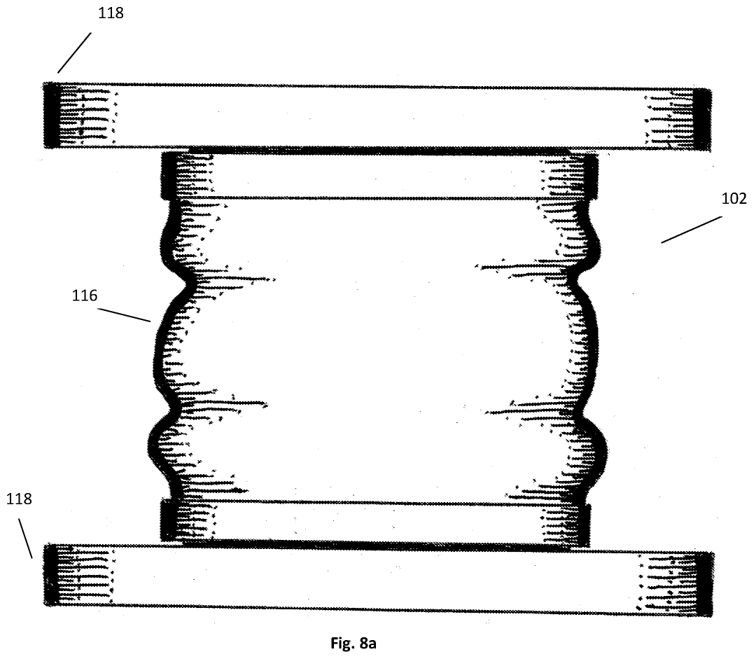

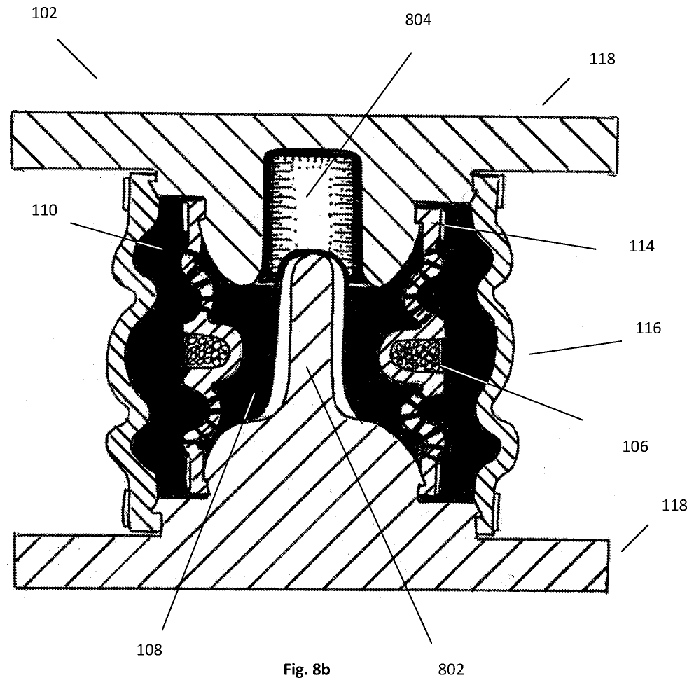

FIG. 8a depicts a side view of another embodiment of a capsule/visco-restrictive damping cartridge 102 in the present device. In some embodiments, a visco-restrictive damping cartridge 102 can have a substantially cylindrical exterior geometry with regular or varying diameters, but in other embodiments can have any other known and/or convenient geometry. A cartridge 102 can have an outer non-porous membrane 116, which can be flexible and comprised of a polymer or any other known and/or convenient material. Mounting plates 118 can be positioned substantially opposite each other on the exterior of a membrane 116. In the embodiments shown in FIG. 8a, mounting plates 118 can be placed at the ends of a substantially cylindrical cartridge 102, but in other embodiments can be placed in any other known and/or convenient location.

FIG. 8b depicts a side cross-sectional view of the embodiment shown in FIG. 8a. An electromagnet 106 can be placed between two substantially concentric magneto-rheologic fluid-containing capsules 108 110. A magneto-rheologic fluid can comprise powdered ferrous oxide, an oil carrier fluid, and a surfactant, or any other known and/or convenient substances. In some embodiments, an electromagnet 106 can have an annular geometry, but in other embodiments can have any other known and/or convenient shape. A flexible, perforated membrane 114 can separate the concentric ferro-fluid filled capsules encased by a second nonporous membrane 116. In some embodiments, a perforated membrane 114 can be formed from a woven fabric or perforated metallic sheet or any other known and/or convenient material. In a first state, ferro-fluid can flow freely through a perforated membrane 114 between capsules, while in a second state can be thickened and inert. However, in some embodiments, a first state can have thickened inert fluid, while in a second state the fluid can be free-flowing.

In the embodiment shown in FIGS. 8a and 8b, mounting plates 118 can further comprise a configuration suitable for selective engagement inside a cartridge 102. As shown in FIG. 8b, one plate 118 can have a substantially central protrusion 802 that can selectively engage with a corresponding receptacle 804 in the opposite plate 118. However, other embodiments can have any other known and/or convenient engagement mechanism. In some embodiments, a protrusion 802 and corresponding receptacle 804 can be located within an inner capsule 108, but in other embodiments can be located in an outer capsule 110 or in any other known and/or convenient position.

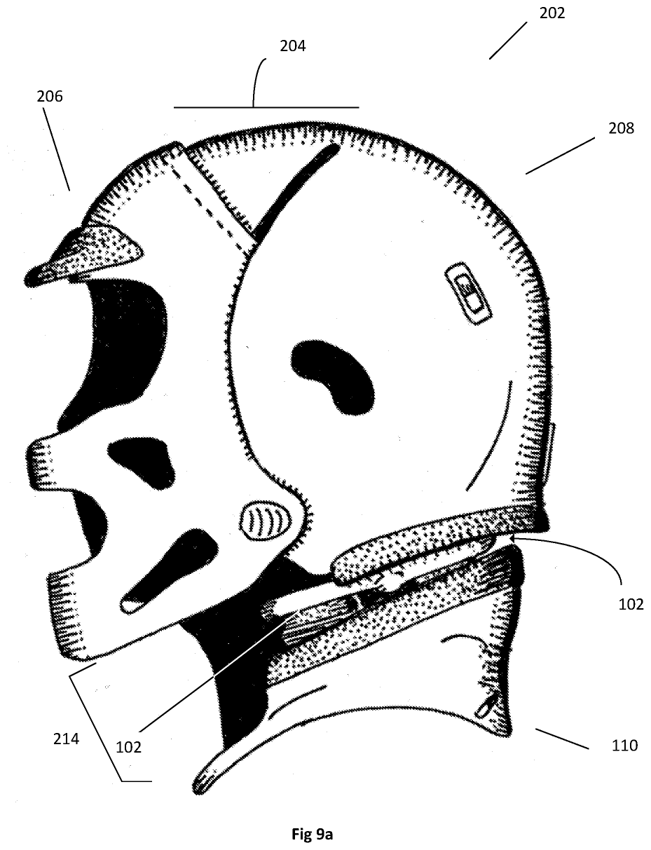

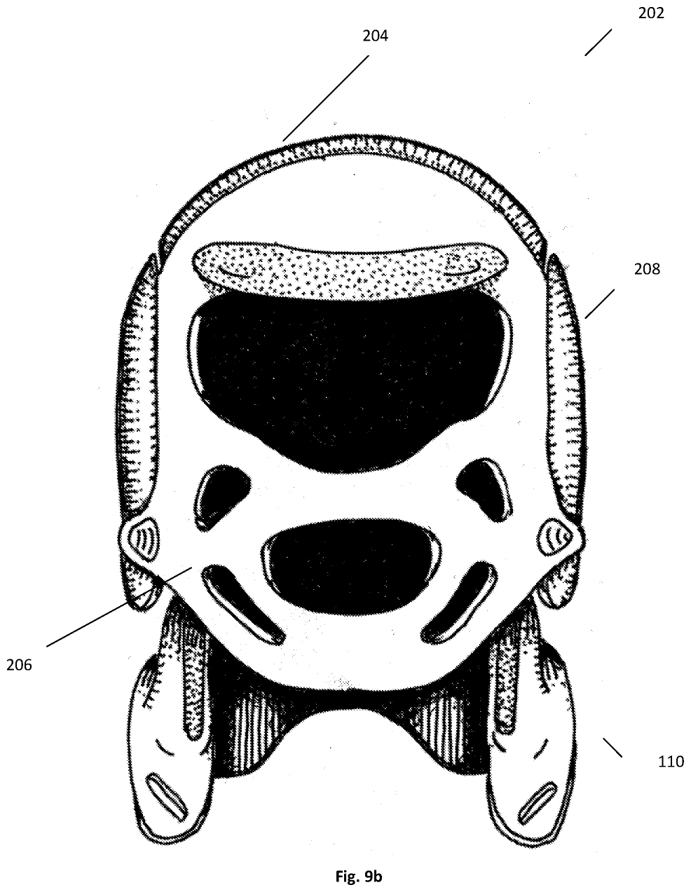

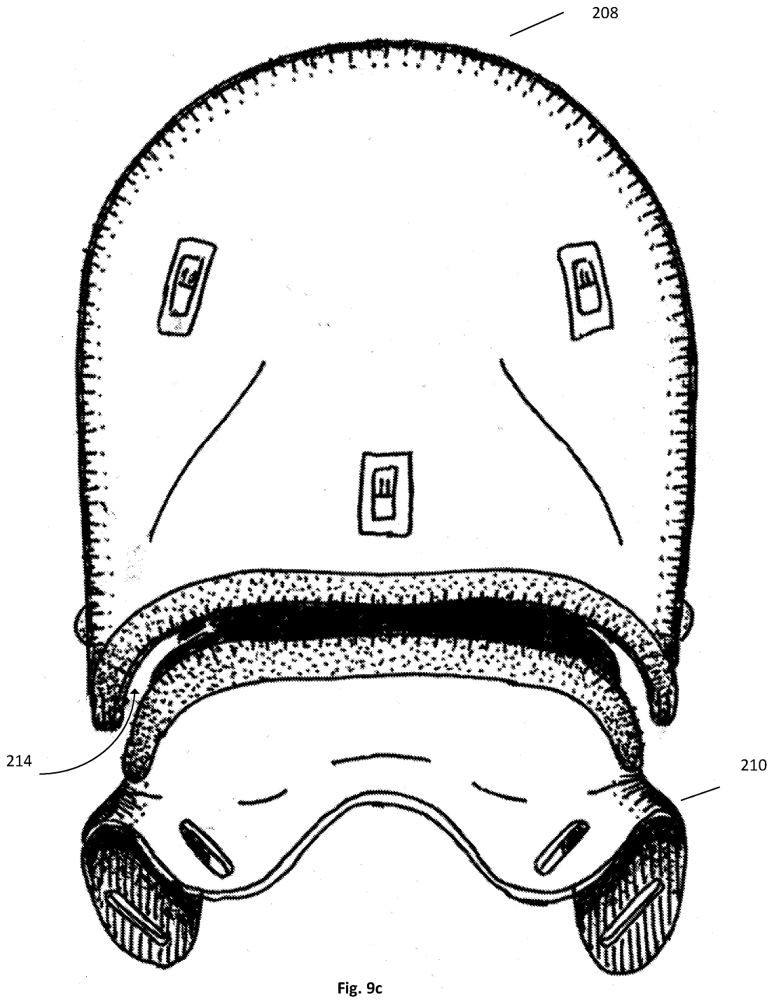

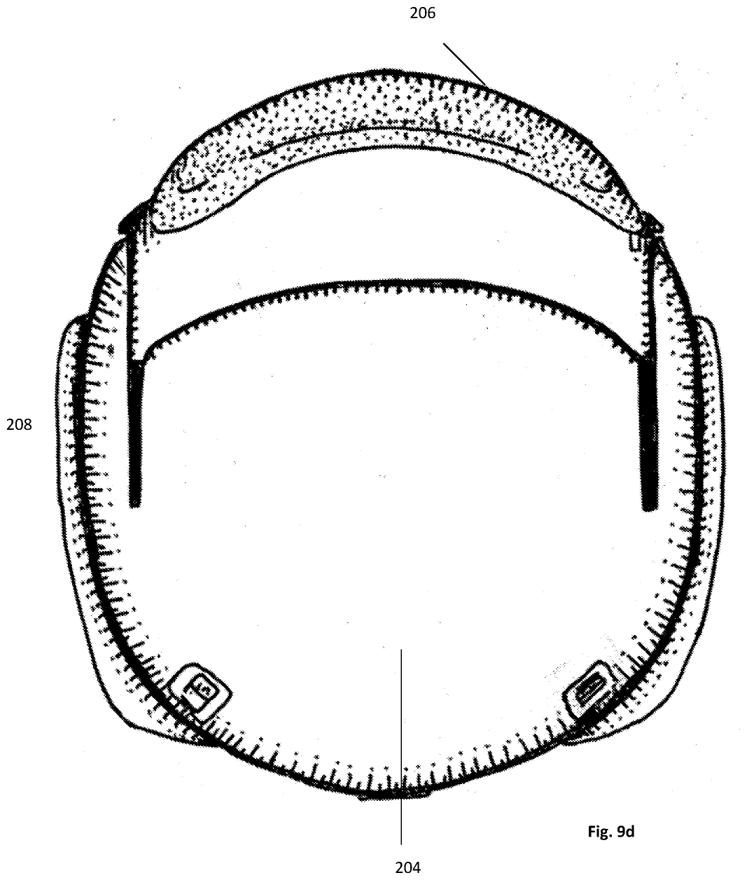

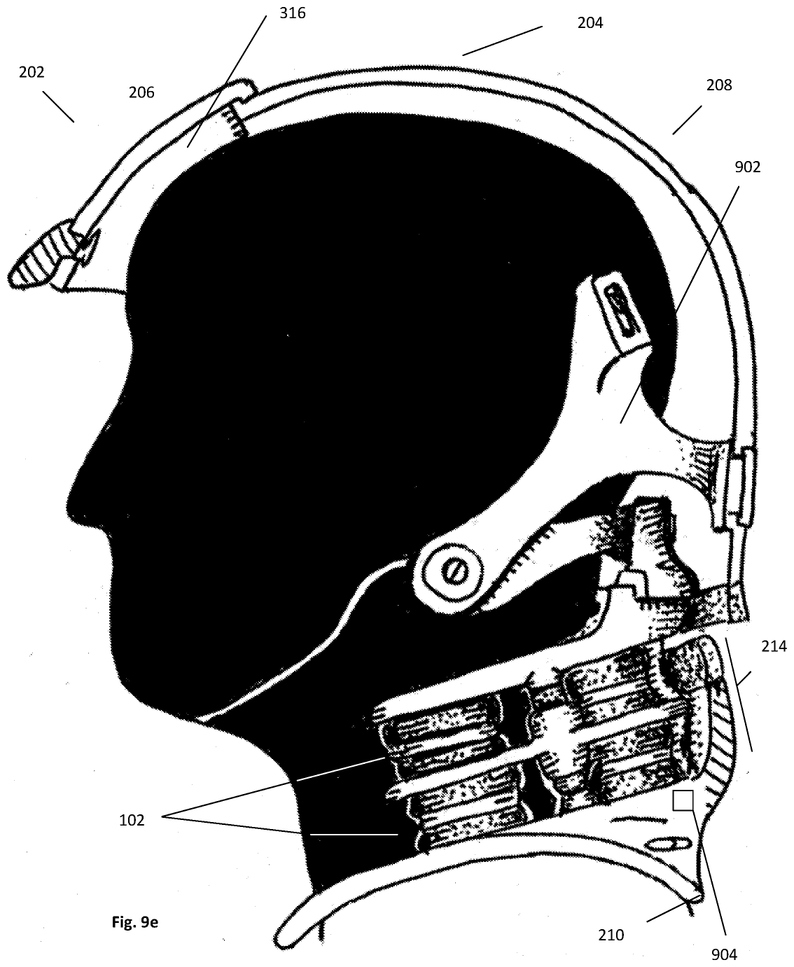

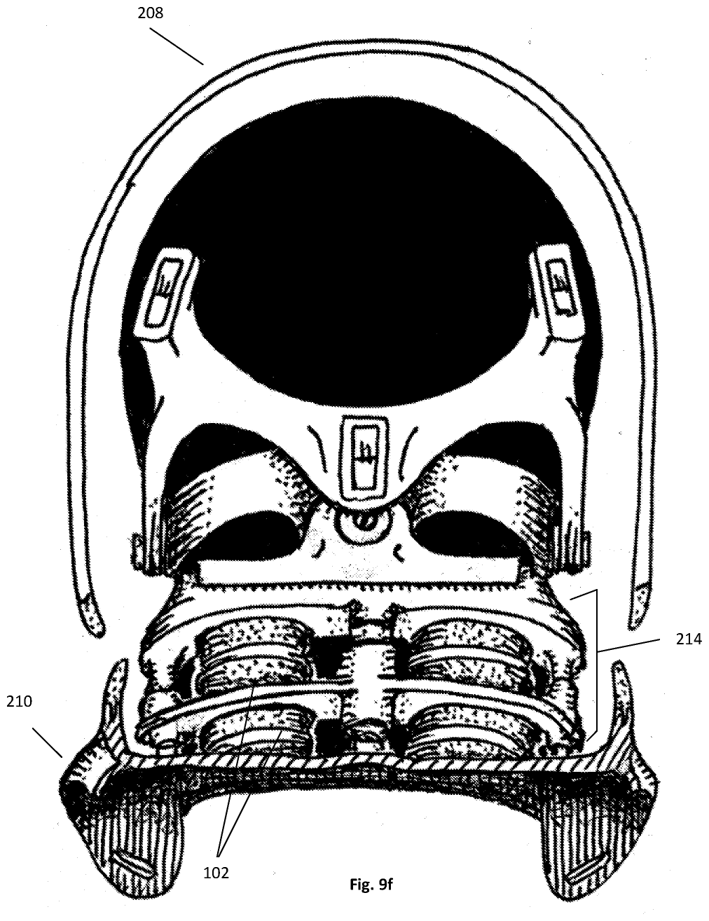

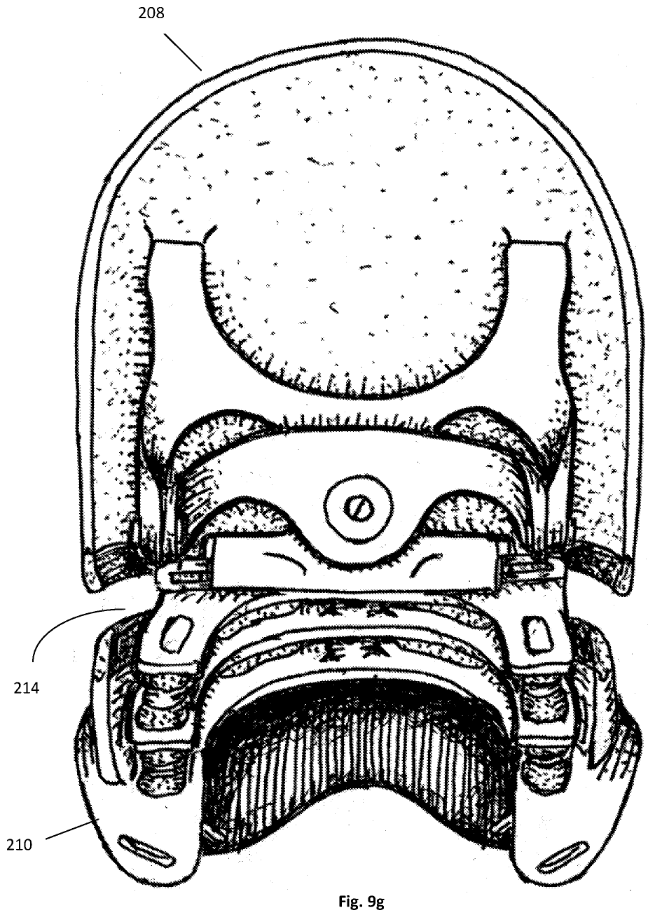

FIG. 9a depicts a side view of another embodiment of the present device with the cartridges 102 shown in FIGS. 8a and 8b in use in a helmet system 202. In such embodiments, visco-damping cartridges 102 can be positioned between a helmet 204 and shoulder plates 210 to comprise a shock-absorbing assembly 214.

FIG. 9b depicts a front view of the embodiment shown in FIG. 9a.

FIG. 9c depicts a rear view of the embodiment shown in FIG. 9a.

FIG. 9d depicts a top view of the embodiment shown in FIG. 9a.

FIG. 9e depicts a side cross-sectional view of the embodiment shown in FIG. 9a. As shown in FIG. 9e, a plurality of visco-damping cartridges 102 can be arranged in a stacked configuration as part of a shock-absorbing assembly 214. In the embodiment depicted in FIG. 9e, the helmet system 202 can comprise a gimbal system 902 that couples the cartridges 102 with the helmet 204. The helmet system 202 can also comprise a power supply 904 coupled with both the sensor package 316 and the cartridge(s) 102. Thus, in operation, when a sensor from the sensor package 316 detects acceleration(s) or movement outside of a prescribed range, the sensor package can transmit a signal to the cartridge(s) 102 to activate the cartridge(s) 102. In such a condition the activated cartridge(s) 102 can inhibit movement of the gimbal system 902 and thus restrain movement of the helmet 204 relative to the shoulder plates 210. While depicted in the present embodiment as a gimbal system 902, in alternate embodiments any known convenient and/or desired configuration or system can be employed such that when activated, the cartridge(s) 102 can inhibit movement of the helmet 204 relative to the shoulder plates 210.

FIG. 9f depicts a rear cross-sectional view of the embodiment shown in FIG. 9a.

FIG. 9g depicts a front cross-sectional view of the embodiment shown in FIG. 9a.

FIG. 9h depicts a bottom cross-sectional view of the embodiment shown in FIG. 9a.

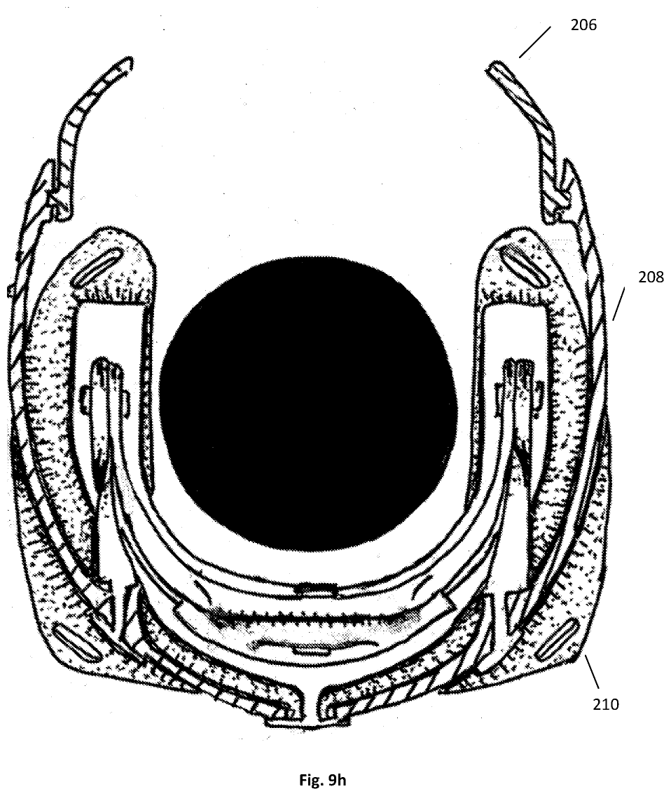

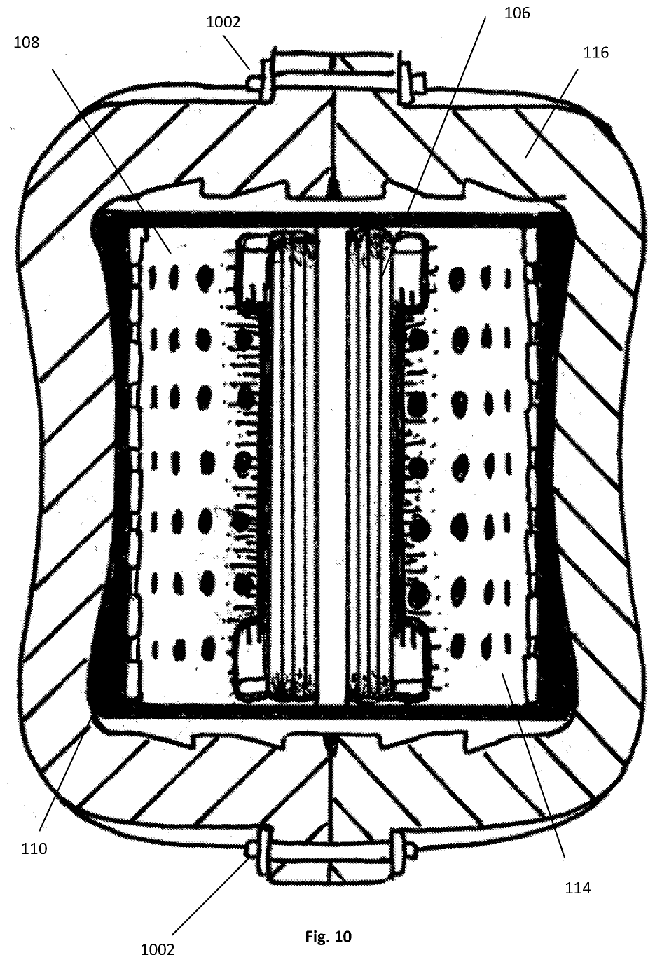

FIG. 10 depicts a side cross-sectional view of another embodiment of the present device. An electromagnet 106 can be placed inside two substantially concentric magneto-rheologic fluid-containing capsules 108 110. A magneto-rheologic fluid can comprise powdered ferrous oxide, an oil carrier fluid, and a surfactant, or any other known and/or convenient substances. In some embodiments, an electromagnet 106 can have a flat plate geometry, but in other embodiments can have a toroid or any other known and/or convenient shape. A flexible, perforated membrane 114 can separate the concentric ferro-fluid filled capsules encased by a second nonporous membrane 116. In some embodiments, a perforated membrane 114 can be formed from a woven fabric or perforated metallic sheet or any other known and/or convenient material. In a first state, ferro-fluid can flow freely through a perforated membrane 114 between capsules. In some embodiments, in a first state the ferro-fluid can be thickened and inert, while in a second state can be free-flowing. However, in other embodiments, a first state have the ferrofluid free-flowing, while in a second state can be thickened and inert. In the embodiment depicted in FIG. 10, the nonporous membrane 116 can be comprised of two components that are coupled with a fastener 1102, such as a pin, nut and bolt, screw and/or any known, convenient and/or desired fastening device or system. However, in alternate embodiments, the nonporous membrane 116 can be of unitary construction and/or can be constructed of any known, convenient and/or desired number of components bonded or held together in any known, convenient and/or desired manner using any known, convenient and/or desired system and/or mechanism and/or bonding system and/or technique.

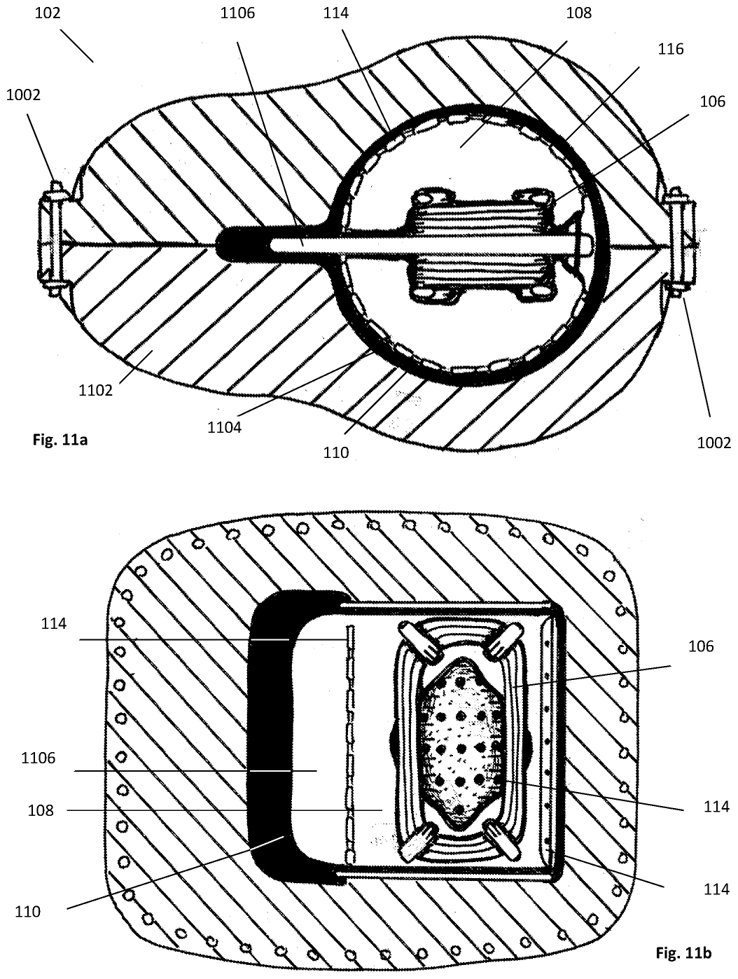

FIG. 11a depicts a top cross-sectional view of another embodiment of the present device. In some embodiments, a visco-damping cartridge 102 can have an outer casing 1102. As shown in FIG. 11a, an outer casing can be comprised of two substantially symmetric halves that when joined together by bolts, screws, weld, or any other known and/or convenient fastener 1002, can form an interior cavity 1104 that can provide a boundary for an outer capsule 110. Said cavity 1104 can be substantially rounded or cylindrical with an extension substantially along the longitudinal axis of a cartridge 102 and contain ferro-magnetic fluid. Inside an interior cavity 1104 can be a plate 1106, wherein a portion of one edge can extend into the extension of a cavity 1104. Electromagnets 106 can be mounted to opposite surfaces of a plate 1106. In some embodiments, an electromagnet can have a toroidal geometry, but in other embodiments can have any other known and/or convenient configuration. A perforated membrane 114 can be attached to a plate 1106, such that it surrounds the portion of a plate 1106 containing an electromagnet 106 and creates an inner capsule 108.

In the embodiment depicted in FIG. 11, the nonporous membrane 116 can be comprised of two components that are coupled with a fastener 1102, such as a pin, nut and bolt, screw and/or any known, convenient and/or desired fastening device or system. However, in alternate embodiments, the nonporous membrane 116 can be of unitary construction and/or can be constructed of any known, convenient and/or desired number of components bonded or held together in any known, convenient and/or desired manner using any known, convenient and/or desired system and/or mechanism and/or bonding system and/or technique.

FIG. 11b depicts a side cross-sectional view of the embodiment shown in FIG. 11a.

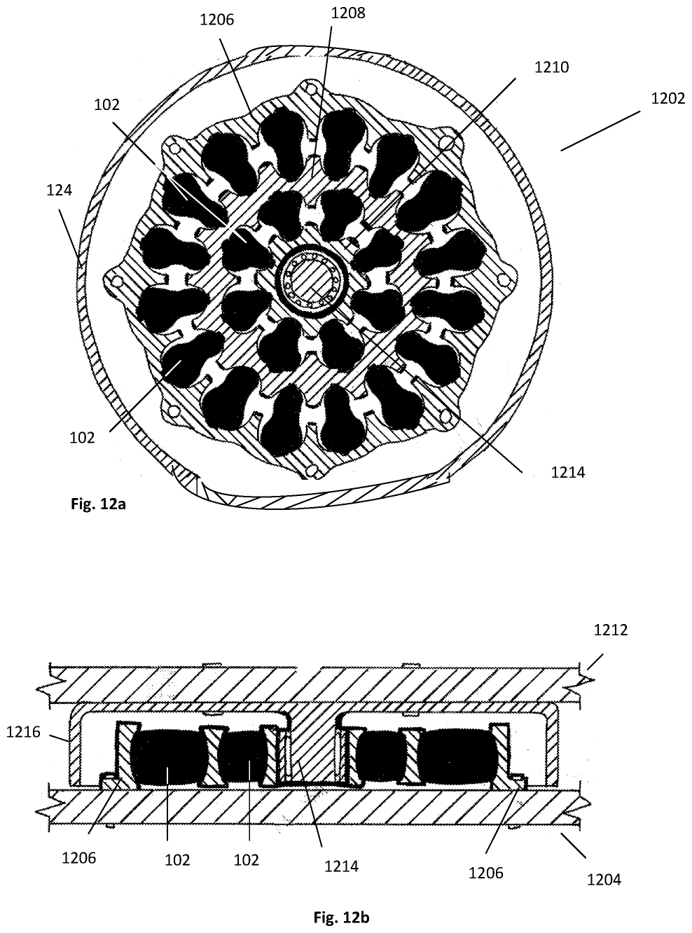

FIG. 12a depicts a top cross-sectional view of an embodiments of the present device in a base isolator device 1202. A base plate 1204 can have a substantially circular geometry, but in other embodiments can have any other known and/or convenient configuration. A first outermost ring 1206 can be connected coaxially along the central axis of a base plate 1204. A first plurality of visco-damping cartridges 102 can be placed inside a first outermost ring 1206 in a radial configuration. A second ring 1208 can be placed inside a plurality of radially placed cartridges 102. A second plurality of cartridges 102 can be placed inside a second ring 1208 in a radial configuration, offset to said first plurality of cartridges 102. A third innermost ring 1210 can be placed inside a second plurality of cartridges 102. As shown in FIG. 12a, rings 1206 1208 1210 can have indentations that can selectively engage with the ends of cartridges 102.

FIG. 12b depicts a side cross-sectional view of the embodiment shown in FIG. 12a. As shown in FIG. 12b, a first outermost ring 1206 can be connected by fasteners, such as, but not limited to bolts, screws, rivets, or welds, to a base plate 1204. A second ring 1208 can be placed between a first plurality of cartridges 102 and a second plurality of cartridges 102. In some embodiments, as shown in FIG. 12b, a second ring 1208 can be held in place by said cartridges 102 such that a second ring 1208 is free to move in a planar manner relative to said base plate 1204. A third ring 1210 connects the second plurality of cartridges 102 to a top plate 1212 via a post 1214 extending from the lower surface of an intermediate plate 1216 that can be attached to the bottom surface of a top plate 1212. In some embodiments, a base plate 1204, a top plate 1212, and an intermediate plate 1216 can have a substantially circular geometry and be positioned concentrically about a central axis, but in other embodiments can have any other known and/or convenient configuration. In some embodiments, an intermediate plate 1216 can have a flange that extends downward substantially perpendicular to a top plate 1212 outside of a first outermost ring 1206. In some embodiments, a base plate 1204, a top plate 1212, an intermediate plate 1216, first outermost ring 1206, a second ring 1208, and a third innermost ring 1210 can be comprised of metal, but in other embodiments can be made of a polymer or any other known and/or convenient material.

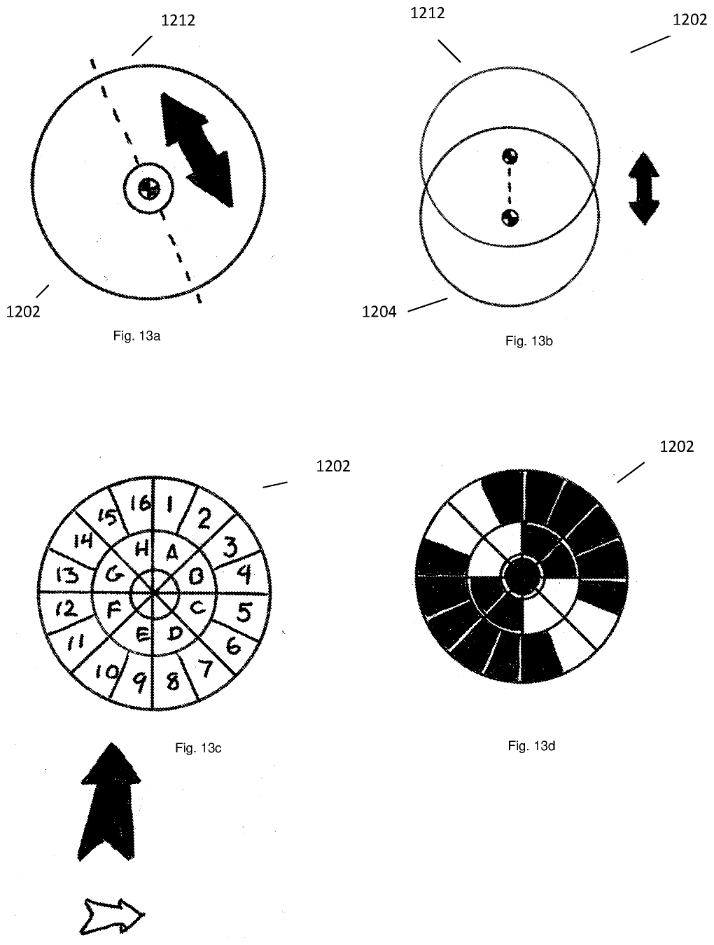

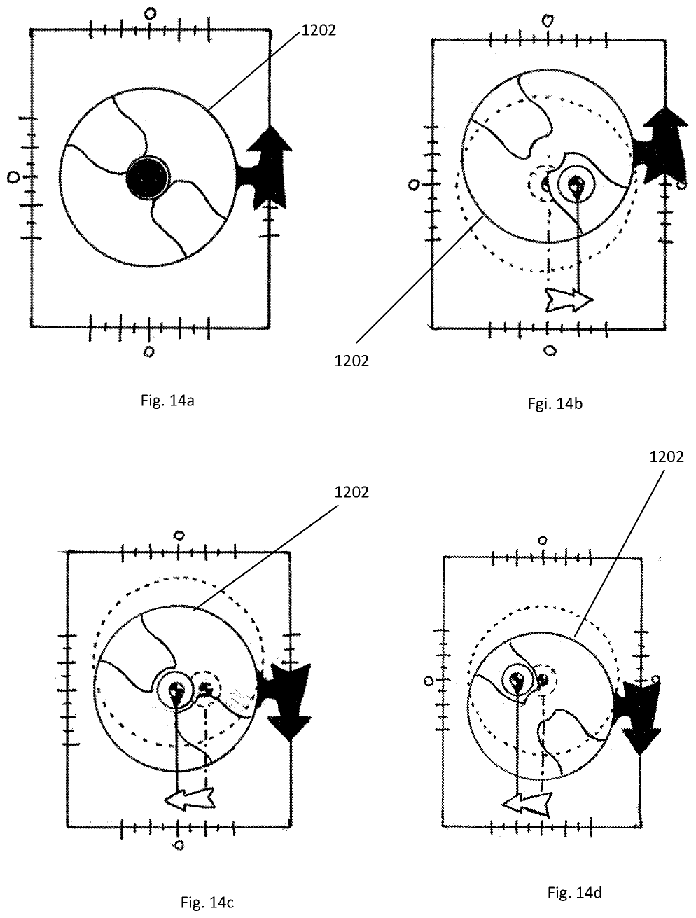

FIGS. 13a-13d depict the action of the embodiment shown in FIGS. 12a-b in use. FIG. 13a is a top view of the top plate 1212 of a base isolator embodiment, with a double arrow indicating a laterally applied force. FIG. 13b depicts the motion of a top plate 1212 relative to a base plate 1204 in use. FIG. 13c depicts a labeling system for the pluralities of cartridges 102 in a base isolator embodiment. FIG. 13d depicts a diagram of cartridges 102 in active or passive states in response to the force shown in FIG. 13a. In some embodiments, the open spaces denote cartridges 102 in a first state, in which the ferrofluid is free-flowing within a cartridge 102, while the filled spaces denote those in a second state, in which ferrofluid is thickened or inert.

FIGS. 14a-d depict diagrams of the relative motions of a top plate 1212 and a bottom plate 1204 of a base isolator embodiment, with arrows indicating the vector components of an applied force. FIG. 14a depicts the top view of a base isolator 1202 at rest in a first state, with a top plate 1212 and a bottom plate 1204 substantially in axial alignment, with a first arrow denoting a force being applied. FIGS. 14b-d depict the motion of a top plate 1212 with application of a force having two non-zero components.

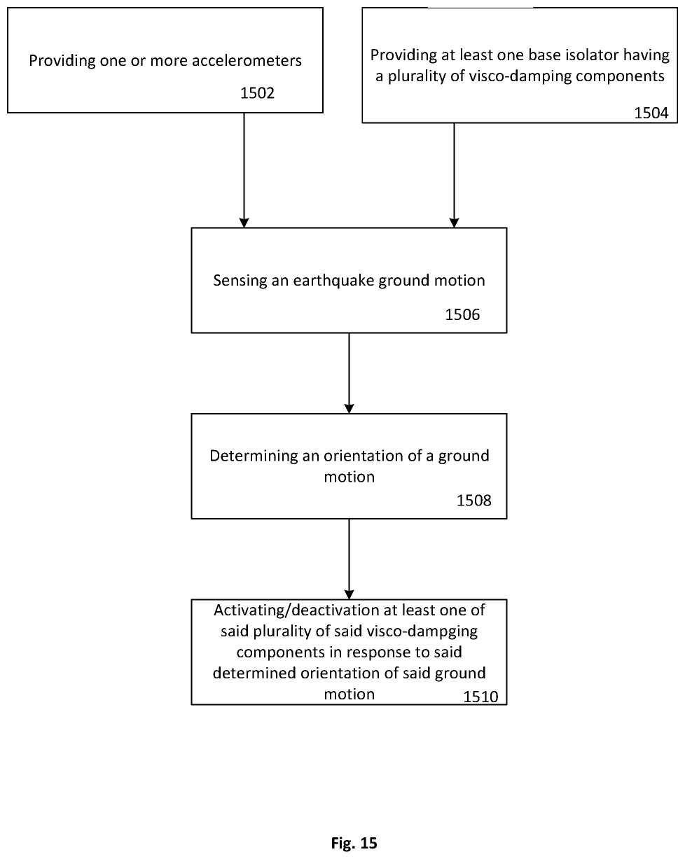

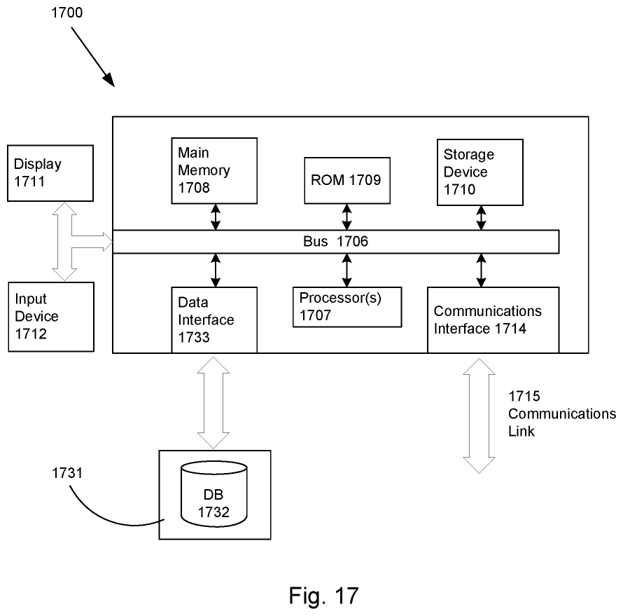

FIG. 15 depicts a flow chart for a method for using an embodiment of the present device. A system can provide at least one accelerometer 1502 and at least one base isolator having a plurality of visco-damping cartridge 102 components 1504. Accelerometers can sense earthquake ground motion 1506 and determine an orientation of a ground motion 1508 relative to the orientation of a structure being supported on the isolator. Input from accelerometers can be processed in a custom-designed computer hardware system (See FIG. 17). At least in part to the response to the orientation of a ground motion 1510 relative to the base isolator(s) of the supported structure, the system can activate or deactivate at least one of said plurality of said visco-damping cartridge 102 components. Thus damping the visco-damping cartridge(s) 102 and the base isolator can attenuate at least a portion of the ground motion felt/transferred to the supported structure.

In some embodiments, as shown in FIG. 15, a base isolator system can be controlled by a computer system that can receive input from accelerometers pertaining to the magnitude, direction, and characteristics of a ground force. A processor can map this information to a base isolator to deactivate or activate individual visco-damping cartridges in response to a force to mitigate damage.

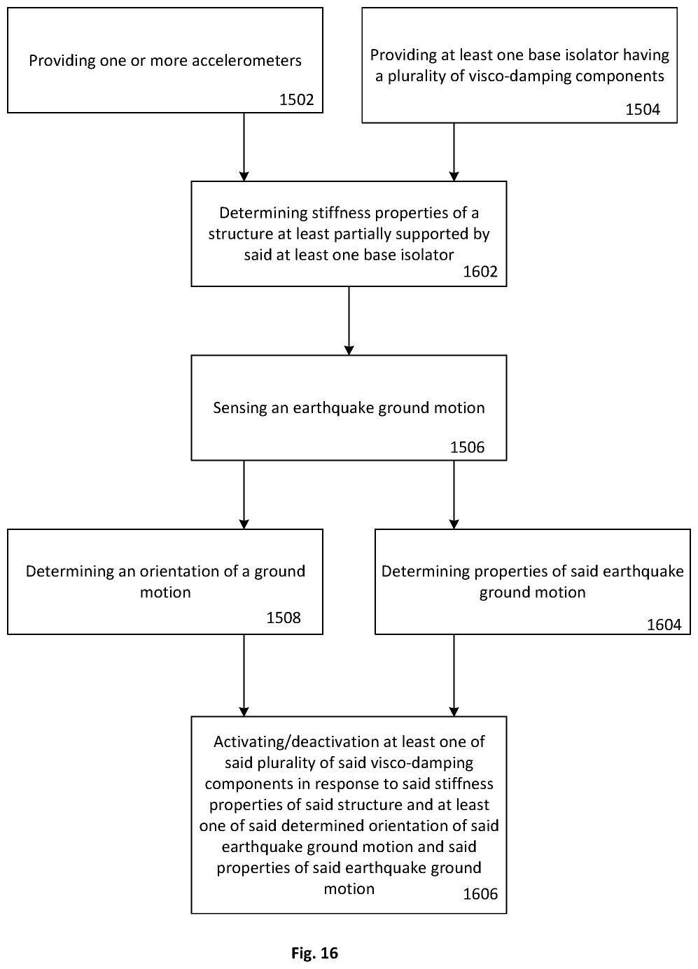

FIG. 16 depicts a flow chart for a method for using another embodiment of the present device. A system can provide at least one accelerometer 1502 and at least one base isolator having a plurality of visco-damping cartridge 102 components 1504. Custom made computer hardware and software can determine the stiffness properties of a structure at least partially supported by said at least one base isolator 1602. Accelerometers can sense earthquake ground motion 1506, determine an orientation of a ground motion 1508, and determine the properties of said earthquake ground motion 1604. Input from accelerometers can be processed in a custom-designed computer hardware system to result in activating or deactivating at least one of said plurality of said visco-damping cartridge 102 components in response to said stiffness properties of said structure and at least one of said determined orientation of said earthquake ground motion and said properties of said earthquake ground motion 1606.

In another embodiment, as shown in FIG. 16, the rigidity/flexibility of the structure can be fed into a computer system and taken into account when activating/deactivating the visco-damping cartridges 102. This step will take into account the calculation of resonant frequencies for the structure and resonant frequencies of the ground motion as changing the rigidity/flexibility of the base isolator overall. This can be used to tune the resonant frequency of the building so that it is out of phase with the resonant frequency of the ground motion to mitigate the effects of ground forces.

In use, in the embodiment shown and described herein, when separation distance between an upper mounting plate 118 and lower mounting plate (not shown) decreases (by way of non-limiting example, as occurs during an impact in a direction substantially normal to an upper mounting plate 118), the volume of an inner portion of a capsule 108 encased by a perforated membrane 114 decreases, forcing ferro-fluid through a perforated membrane 114 into the outer portion 110, which can cause a second non-porous membrane 116 to expand. This transfer of fluid can be brought progressively to a halt when sensors activate an electrical current transferred through wires 124 to an electromagnet 106, which can cause a ferro-fluid to thicken in a gradual, sudden, linear, non-linear, curvilinear, or any other known and/or convenient manner While in a first state a fluid can remain thin and flow freely in two directions through a non-elastic porous membrane 114, permitting unimpeded flexing of a cartridge 102. In this state, an outer membrane 116, which can be flexible, can expand and contract as volume within an inner cavity 108 varies. While in a second state a fluid can be thickened and inert, preventing flexing of a cartridge 102.

In some embodiments, the free-flowing state can be considered “passive”, while the thickened state caused by the activation of the electromagnet 106 can be considered “active”.

Some embodiments of this damping cartridge design can be incorporated into head protection by virtue of elegant simplicity and rugged construction, such as those depicted and described herein. In some embodiments, a sensor package 316 can contain accelerometers to detect initial impact forces. In such embodiments, relays can open and release electric charge, stored in capacitors 306, energizing electro-magnets 106. Activation of electro-magnets 106 can create a magnetic field such that iron particles within ferro-fluid contained in a cartridge 102 can become temporarily magnetized and align into chains to form a Rosensweig instability. This effect can transform a ferro-fluid into a semi-solid gel. In such embodiments, this gel, assisted by electrically applied brake calipers, can lock up helmet sliders 308 310 and rotators 312 314, preventing further motion between a helmet 204 and shoulder plates 210. With solidification of a ferro-fluid, impact forces to a helmet 204 can be transferred to shoulder plates 210 and dissipated to a wearer's torso, preventing or significantly reducing accelerative and rotational forces which would otherwise injure brain tissue.

In other embodiments, when a cartridge 102 is compressed, the volume of an inner portion of a capsule 108 encased by a perforated membrane 114 decreases, forcing ferro-fluid through a perforated membrane 114 into an outer portion 110, which can cause a second non-porous membrane 116 to expand. This transfer of fluid can be brought progressively to a halt when sensors activate an electrical current transferred through wires 124 to an electromagnet 106, which causes the ferro-fluid to thicken.

In operation, the magneto-rheologic fluid can flow freely within a cartridge 102 when current is not applied to the electromagnet(s) 106. However, when current is applied to the electromagnet(s) 106 the magneto-rheologic fluid can thicken and the relative flexibility/stiffness of the cartridge 102 can change as fluid will not as readily pass through the perforations with in the perforated porous membrane 114. In operations, current can be applied as desired to control the viscosity of the magneto-rheologic fluid and thus control the stiffness/flexibility of a cartridge 102.

In other embodiments, such as depicted and described herein, an object can be coupled with a connector element 610 and the lead of the electromagnet(s) 106 can be coupled with a variable power source. The power source can then be varied in any known, convenient and/or desired manner to control the viscosity of the magneto-rheologic fluid and thus control the movement of a porous paddle 606 through the magneto-rheologic fluid, thus controlling the stiffness/flexibility of a connector element 610.

In other embodiments, such as a base-isolator cartridge 102 shown in FIGS. 11a-b, the ferro-magnetic fluid can be in a first state, in which the ferrofluid is thickened and inert (“active”). In such embodiments, a plate 1106 can be held stationary inside of an inner cavity 1104. Changing the ferro magnetic fluid to free-flowing state can allow a plate 1106 to translate substantially along the longitudinal axis of a cartridge 102 with an inner cavity 1104.

In the embodiment shown in FIGS. 12a-b, a plurality of base-isolator cartridges, such as those shown in FIGS. 11a-b, are arranged between a series of plates. In a first state, the ferrofluid can be thickened and inert, holding a top plate 1212 stationary and in substantially axial alignment with a base plate 1204. In some embodiments, this can be considered an “active” state since electromagnets 106 would be activated to thicken the ferrofluid.

The execution of the sequences of instructions required to practice the embodiments can be performed by a computer system 1700 as shown in FIG. 17. In an embodiment, execution of the sequences of instructions is performed by a single computer system 1700. According to other embodiments, two or more computer systems 1700 coupled by a communication link 1715 can perform the sequence of instructions in coordination with one another. Although a description of only one computer system 1700 will be presented below, however, it should be understood that any number of computer systems 1700 can be employed to practice the embodiments.

A computer system 1700 according to an embodiment will now be described with reference to FIG. 17, which is a block diagram of the functional components of a computer system 1700. As used herein, the term computer system 1700 is broadly used to describe any computing device that can store and independently run one or more programs.

Each computer system 1700 can include a communication interface 1714 coupled to the bus 1706. The communication interface 1714 provides two-way communication between computer systems 1700. The communication interface 1714 of a respective computer system 1700 transmits and receives electrical, electromagnetic or optical signals, that include data streams representing various types of signal information, e.g., instructions, messages and data. A communication link 1715 links one computer system 1700 with another computer system 1700. For example, the communication link 1715 can be a LAN, in which case the communication interface 1714 can be a LAN card, or the communication link 1715 can be a PSTN, in which case the communication interface 1714 can be an integrated services digital network (ISDN) card or a modem, or the communication link 1715 can be the Internet, in which case the communication interface 1714 can be a dial-up, cable or wireless modem.

A computer system 1700 can transmit and receive messages, data, and instructions, including program, i.e., application, code, through its respective communication link 1715 and communication interface 1714. Received program code can be executed by the respective processor(s) 1707 as it is received, and/or stored in the storage device 1710, or other associated non-volatile media, for later execution.

In an embodiment, the computer system 1700 operates in conjunction with a data storage system 1731, e.g., a data storage system 1731 that contains a database 1732 that is readily accessible by the computer system 1700. The computer system 1700 communicates with the data storage system 1731 through a data interface 1733. A data interface 1733, which is coupled to the bus 1706, transmits and receives electrical, electromagnetic or optical signals, that include data streams representing various types of signal information, e.g., instructions, messages and data. In embodiments, the functions of the data interface 1733 can be performed by the communication interface 1714.

Computer system 1700 includes a bus 1706 or other communication mechanism for communicating instructions, messages and data, collectively, information, and one or more processors 1707 coupled with the bus 1706 for processing information. Computer system 1700 also includes a main memory 1708, such as a random access memory (RAM) or other dynamic storage device, coupled to the bus 1706 for storing dynamic data and instructions to be executed by the processor(s) 1707. The main memory 1708 also can be used for storing temporary data, i.e., variables, or other intermediate information during execution of instructions by the processor(s) 1707.

The computer system 1700 can further include a read only memory (ROM) 1709 or other static storage device coupled to the bus 1706 for storing static data and instructions for the processor(s) 1707. A storage device 1710, such as a magnetic disk or optical disk, can also be provided and coupled to the bus 1706 for storing data and instructions for the processor(s) 1707.

A computer system 1700 can be coupled via the bus 1706 to a display device 1711, such as, but not limited to, a cathode ray tube (CRT) or a liquid-crystal display (LCD) monitor, for displaying information to a user. An input device 1712, e.g., alphanumeric and other keys, is coupled to the bus 1706 for communicating information and command selections to the processor(s) 1707.

According to one embodiment, an individual computer system 1700 performs specific operations by their respective processor(s) 1707 executing one or more sequences of one or more instructions contained in the main memory 1708. Such instructions can be read into the main memory 1708 from another computer-usable medium, such as the ROM 1709 or the storage device 1710. Execution of the sequences of instructions contained in the main memory 1708 causes the processor(s) 1707 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 1707. Such a medium can take many forms, including, but not limited to, non-volatile, volatile and transmission media. Non-volatile media, i.e., media that can retain information in the absence of power, includes the ROM 1709, CD ROM, magnetic tape, and magnetic discs. Volatile media, i.e., media that can not retain information in the absence of power, includes the main memory 1708. Transmission media includes coaxial cables, copper wire and fiber optics, including the wires that comprise the bus 1706. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes can be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention can be implemented in a variety of computer systems. The various techniques described herein can be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language can be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system can also be considered to be implemented as a computer-readable storage medium, configured with a computer program, where the storage medium so configured causes a computer to operate in a specific and predefined manner. Further, the storage elements of the exemplary computing applications can be relational or sequential (flat file) type computing databases that are capable of storing data in various combinations and configurations.

In the embodiment shown in FIGS. 2a-e, 3, and 9a-h a cartridge 102 can be applied to a stabilization method for excessive and potentially harmful neck motion. At least one cartridge 102 can be incorporated into a helmet damper connection unit 216. In such embodiments, as shown in FIG. 9f, there can be four cartridges 102 placed in a stacked configuration between mounting plates 218, but in other embodiments any other quantities of cartridges 102 can be placed in any other known and/or convenient configuration. In some embodiments, a sensor package 316 can be electrically connected to a power supply 302, which can supply electric current to a cartridge 102.

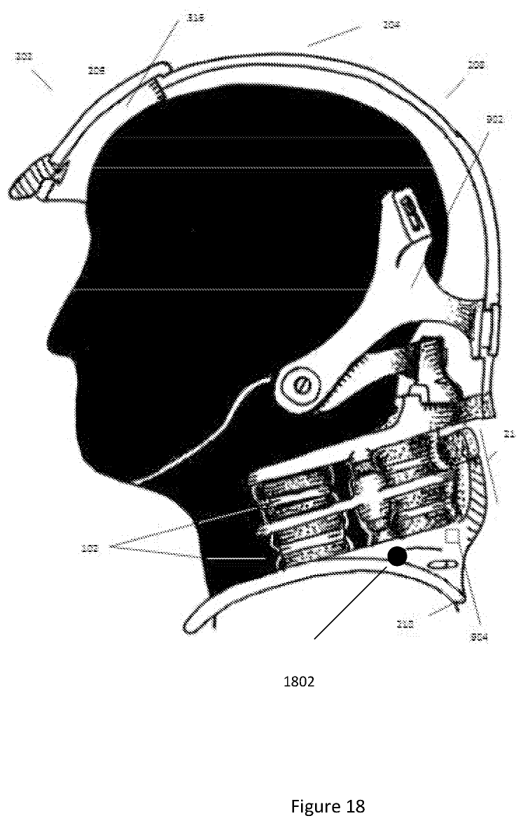

FIG. 18 depicts the embodiment shown in FIGS. 2a-e, 3, and 9a-h with the added feature of an off switch 1802. In some embodiments, an off switch 1802 can be manually operated, but in other embodiments can be a timer device. In such embodiments, when cartridges 102 are activated such that the magneto-rheologic fluid is thick and a cartridge 102 is rigid, an off switch can cut the electrical current to electromagnets 106 to render the magneto-rheologic fluid thinner and, therefore, allowing motion between a helmet 204 and shoulder plates 210 and head and neck motion.

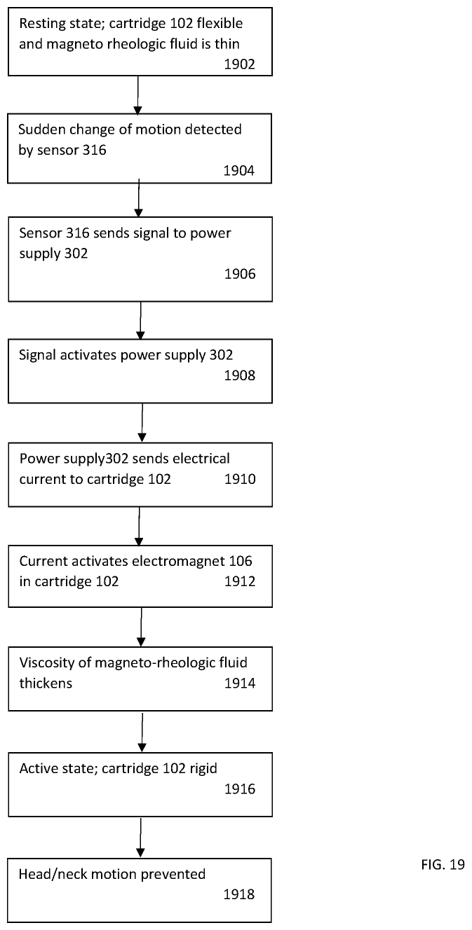

FIG. 19 depicts a flow diagram of the operation of the embodiment shown in FIGS. 2a-e, 3, 9a-h and 18. In a resting state 1902, a magneto-rheologic fluid can have a low viscosity and can readily pass through a flexible, perforated membrane 114. In this resting state 1902, no electric current is applied to an electromagnet 106 within a cartridge 102. Therefore, natural head and neck movement is permitted between a helmet 204 and shoulder plates 210,

A sensor package 316 can include an accelerometer, which can detect sudden changes in motion 1904 and send a signal 1906 to a power supply 302. A signal can activate 1908 a power supply 302 to send an electrical current 1910 to an electromagnet 106. Electrical current can activate 1912 an electromagnet 106 in a cartridge 102. Activating an electromagnet 106 can cause the viscosity of magneto-rheologic fluid to increase 1914 such that the fluid cannot pass through a flexible, perforated membrane 114. In this active state 1916, cartridges 102 can become rigid, immobilizing mounting plates 218 to prevent excessive and potentially harmful head and neck movement 1918.

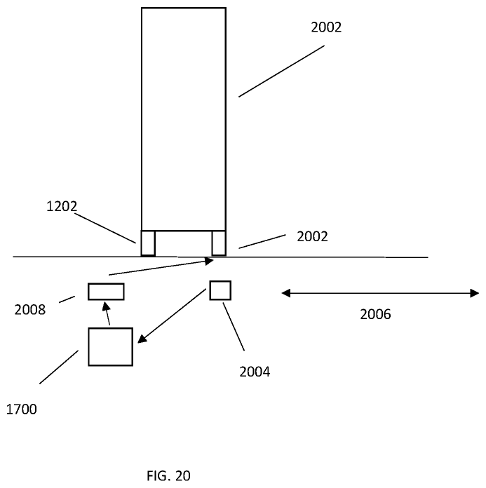

FIG. 20 depicts a schematic diagram of a base isolator system in use. A superstructure can be supported by a plurality of base isolators 1202. A sensor 2004 can be an accelerometer or any other known and/or convenient device that can sense the ground motion 2006 caused in an earthquake. A sensor 2004 can be electrically connected to a control system 1700, which can be electrically connected to a power supply 2008. A power supply 2008 can be electrically connected to cartridges 102 in a base isolator 1202 to control the amount of current to an electromagnet 106 and change the viscosity of the magneto rheologic fluid.

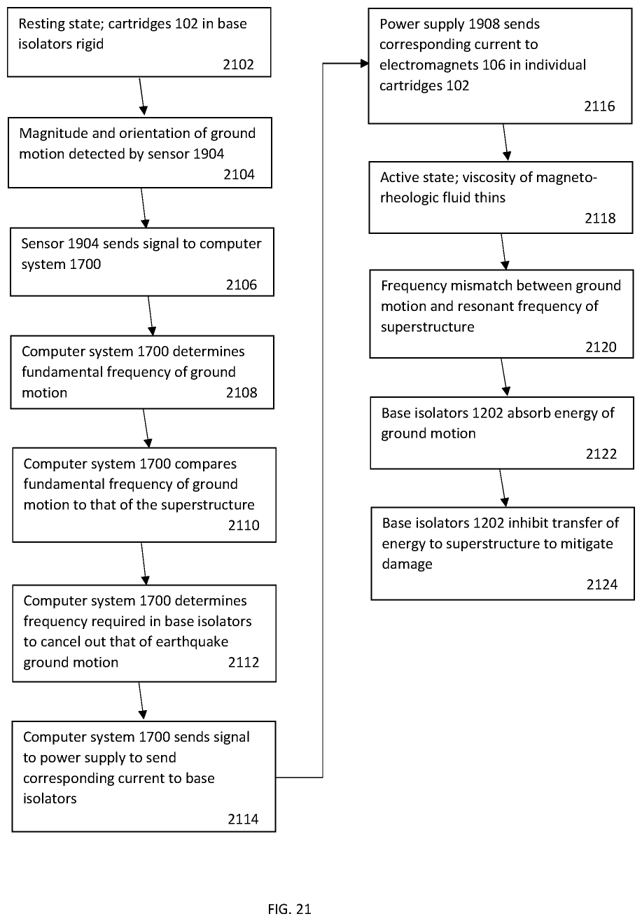

FIG. 21 depicts a flow diagram of the operation of the embodiment shown in FIGS. 10, 11a-b, 12a-b, 13a-d, 14a-d, and 15-17. In a resting state 2102, a magneto-rheologic fluid in a cartridge 102 in a base isolator 1202 can have a high viscosity such that it cannot pass through a flexible, perforated membrane 114, making a cartridge 102 rigid. In this resting state 2102, an electric current can be applied to an electromagnet 106 within a cartridge 102. Therefore, a superstructure 1902 can be fully supported sitting on top of base isolators 1202.

A sensor 1904 can detect sudden changes in the magnitude and orientation of a ground motion 2104 and send a signal 2106 to a computer system 1700. A computer system 1700 can include data on the fundamental resonant frequency of a superstructure 1902. A computer system 1700 can determine the fundamental frequency 2108 of the ground motion of an earthquake 1906 and can compare it to the fundamental resonant frequency of a superstructure 2110. A computer system 1700 can calculate the frequency required in base isolators 1202 to cancel out the frequency of the ground motion of an earthquake 1906 2112 and send a signal to a power supply 1908 2114 to send the corresponding electrical current 2116 to an electromagnet 106. This can cause the viscosity of magneto-rheologic fluid to decrease such that the fluid can pass through a flexible, perforated membrane 114. In this active state 2118, cartridges 102 can become flexible to varying degrees to allow motion of base isolators 1202.

Varying the electrical current sent to electromagnets 106 in cartridges 102 can tune individual cartridges 102 in a base isolator 1202 to create a frequency mismatch 2120 between ground motion of an earthquake 1906 and the resonant frequency of a superstructure 1902. In this way, cartridges 102 in a base isolator 1202 can absorb the energy of the ground motion of an earthquake 1906 2122 and inhibit the transfer of this energy to a superstructure 1902 to mitigate earthquake damage 2124.

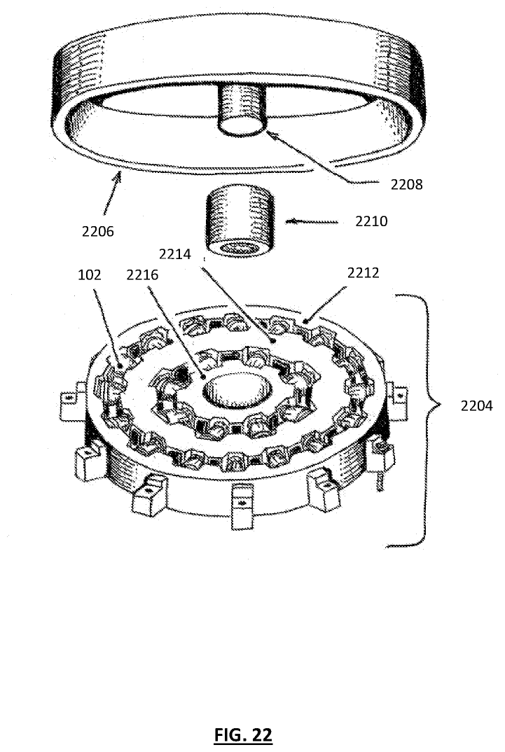

FIG. 22 depicts a perspective assembly view of another embodiment of an isolator unit in use. In such embodiments, a base isolator device 2202 can have a base plate 2204 and a top plate 2206. A top plate 2206 can have a substantially perpendicular rim 2208 extending downward from the outer perimeter of a top plate 2206. A substantially cylindrical member 2210 can extend downward substantially from the center of top plate 2206 and can selectively engage with a base plate 2204 via an opening 2212 and can further comprise a bushing 2214.

A base plate 2204 can have a substantially circular geometry, as shown in FIG. 22, but in other embodiments can have any other known and/or convenient configuration. In such embodiments, a first outermost ring 2216 can be connected coaxially along the central axis of a base plate 2204. A first plurality of visco-damping cartridges 102 can be placed inside a first outermost ring 2216 in a substantially radial configuration. A second ring 2218 of a base plate 2204 can be located inside a first plurality of radially placed cartridges 102. A second plurality of cartridges 102 can be placed inside a second ring 2218 in a substantially radial configuration, offset to said first plurality of cartridges 102. A third innermost ring 2220 of a base 2204 can be located inside a second plurality of cartridges 102. As shown in FIG. 22, rings 2216 2218 2220 can have indentations that can selectively engage with the ends of cartridges 102. In some embodiments at least one mounting component 222 can extend substantially perpendicular from the side and bottom edge of a base plate 2204.

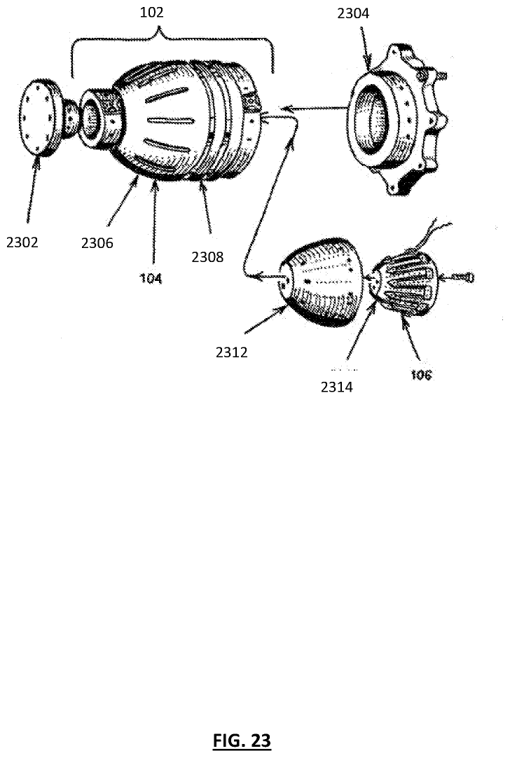

FIG. 23 depicts a perspective assembly view of another embodiment of the present device used in the embodiment shown in FIG. 22. In some embodiments, a cartridge 102 can have a top plate 2302 and a bottom plate 2304 with an outer membrane 2306 positioned and secured between a top plate 2302 and a bottom plate 2304. At least one ring 2308 can circumferentially engage with an outer membrane 2306.

A second membrane 2312 can be placed within and substantially coaxial with the central longitudinal axis of an outer membrane 2306. This can create a space 104 between an outer membrane 2306 and a second membrane 2312. A third perforated membrane 2314 can be placed within and substantially coaxial with the central longitudinal axis of a second membrane 2312. This can create a space 106 between a second membrane 2312 and a third perforated membrane 2314.

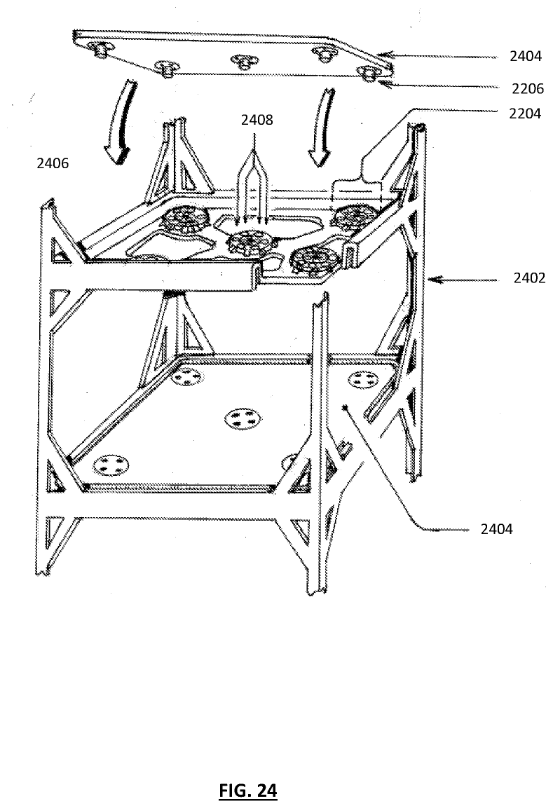

FIG. 24 depicts a perspective view of the embodiment shown in FIG. 22 in use. A structure 2402 can have multiple floors 2404. Each floor 2404 can comprise a lower component 2406 and an upper component 2408. A lower component 2406 can further comprise a plurality of openings 2410. To install an isolator unit 2202 in a structure 2402, base plate 2204 can be secured to a lower floor component 2406 and a top plate 2206 to an upper component 2408 of a floor 2404, such that a top plate 2206 selectively engages with a corresponding base plate 2204. In some embodiments, a plurality of isolator units 2202 can be secured in a pattern having one substantially in the center and one at each corner of a lower floor component 2406. However, in other embodiments isolator units 2202 can be in arranged in any other known and/or convenient configuration.

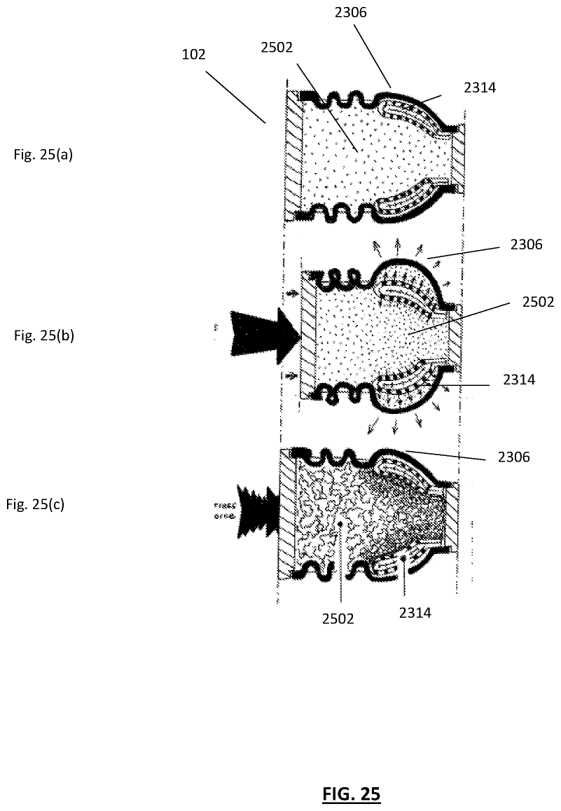

FIGS. 25a-c depict a top view of the embodiment shown in FIG. 23 in use. As shown in FIG. 25a, a cartridge 102 can be in a non-stressed and resting state. Ferrofluid 2502 can freely move through a third perforated membrane 2314 and an electromagnet controlling the viscosity of ferrofluid 2502 is inactive (off). Space between an outer membrane 2306 and a third perforated membrane 2314 is minimal.

In FIG. 25b, a stress force, from such as, but not limited to, a seismic force, compresses a cartridge 102. A custom computer processing system can determine whether resistance is required to counter the force. If not, an electromagnet remains inactive (off) and ferrofluid 2502 can freely move through a third perforated membrane 2314 to fill the space between an outer membrane 2306 and a third perforated membrane, therefore providing minimal resistance to an applied force.

In FIG. 25c, in the case of a stronger force, a custom computer processing system can determine that resistance is required. In this situation, an electromagnet is activated (turned on). Metal particles in a ferrofluid 2502 form a Rosenzweig Instability, spreading filaments throughout the cavity within an outer membrane 2306. Stress from the applied force causes movement of ferrofluid 2502, which can cause filament clumps that can clog the holes in a third perforated membrane 2314. Ferrofluid 2502 can be prevented from moving outside of a third perforated membrane and can, therefore, provide resistance to an applied force.

In use, when forces from a seismic motion are transferred to a structure, a swaying motion can occur at levels above the base of the structure. Cartridges 102 can be in a resting state in which said cartridges 102 are inactive; the ferrofluid can flow freely throughout the cartridge. A motion sensor can detect the orientation and magnitude of structural swaying motion and send a signal to a computer system 1700. A computer system 1700 can be activated and can determine the magnitude and direction of a force created by a swaying motion of a structure. A computer system 1700 can compare a force to a predetermined force likely to cause damage to the structure. If an applied force is of a predetermined magnitude, a computer system 1700 can send a signal to a power supply to send corresponding current electromagnets 106 in cartridges 102. This can produce an active state in which current to electromagnets 106 can be increased to thicken the magneto-rheologic fluid within cartridges 102 and provide a resistance force that can inhibit the transfer of force to a superstructure to mitigate damage.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed:

1. A system to mitigate damage to a superstructure resulting from a swaying motion, comprising:
a plurality of viscosity-damping cartridges, each cartridge having
an elastically deformable sealed exterior housing;
a perforated interior housing wholly contained within said exterior housing having at least one perforation;
a visco-adaptive fluid contained with said exterior housing; and
an activating system adapted to selectively modify the viscosity of said visco-adaptive fluid;
wherein said cartridges are arranged between an upper plate and a lower plate to further comprise an isolator unit and wherein said upper plate and said lower plate are removably connected by a substantially central member;
a power supply electrically connected to said cartridges;
a computer system connected to said power supply, said computer system comprising a set of data pertaining a superstructure; and
a motion sensor in electrical communication with said computer system.

2. The system of claim 1, wherein said upper plate and said lower plate have a substantially circular geometry.

3. The system of claim 2, wherein said lower plate further comprises an outermost ring, an interior ring, and an innermost ring, wherein said outermost, interior, and innermost rings are arranged substantially concentrically about the central longitudinal axis of said base plate.

4. The system of claim 3, wherein said cartridges are arranged in a substantially radial pattern and wherein a first set of cartridges is positioned between the outermost ring and the interior ring, and a second set of cartridges is positioned between the interior ring and the innermost ring.

5. The system of claim 4, wherein said outermost ring, said interior ring, and said innermost ring further comprise lateral indentations to selectively engage with said cartridges.

6. The system of claim 5, wherein said visco-adaptive fluid is adapted to pass through said at least one perforation absent substantial resistance when said visco-adaptive fluid is in a non-activated state.

7. The motion damper of claim 5, wherein said visco-adaptive fluid is adapted to pass through said at least one perforation with substantial resistance when said visco-adaptive fluid is in an activated state.

8. The system of claim 7, wherein said visco-adaptive fluid in magneto-rheologic and is activated by an electromagnet.

9. The system of claim 7, further comprising an upper floor component and a lower floor component arranged substantially parallel to each other, wherein a plurality of isolator units are placed such that the top plates are connected with the bottom surface of an upper floor component and corresponding base plates are connected with the top surface of a lower floor component.

10. A method to mitigate damage to a superstructure resulting from a swaying motion, comprising the steps of:
placing motion damper cartridges comprising electromagnets at rest in an inactive state;
detecting the orientation and magnitude of a structural swaying motion with sensors;
sending a signal to a computer system via said sensors;
activating said computer system;
determining the magnitude and direction of a force created by a swaying motion of a structure with said computer system;
comparing said force to a predetermined force likely to cause damage to the structure;
sending a signal to a power supply to send corresponding electrical current to said cartridges;
adjusting and sending electrical current to said electromagnets in individual motion damper cartridges;
increasing said electrical current to said electromagnets to thicken the magneto-rheologic fluid to create an active state; and
inhibiting the transfer of force to a superstructure via isolator units to mitigate damage.
